(19) United States
(12) Patent Application Publication
(10) Pub. No.: US 2001/0036979 A1
(43) Pub. Date: Nov. 1, 2001

(54) Coloring composition, ink-jet ink and ink-jet recording method

(76) Inventors: Junichi Yamanouchi, Kanagawa (JP); Makoto Yamada, Kanagawa (JP)

Correspondence Address: BURNS DOANE SWECKER & MATHIS L L P, POST OFFICE BOX 1404, ALEXANDRIA, VA, 22313-1404, US

(21) Appl. No.: 09/800,649

(22) Filed: Mar. 8, 2001

(30) Foreign Application Priority Data
Mar. 21, 2000 (JP) 2000-78531
Jul. 5, 2000 (JP) 2000-203857

(51) Int. Cl. C09D 5/00; C08K 5/48; C08K 5/34

(52) U.S. Cl. 523/161; 524/86; 524/92

(57) ABSTRACT

An ink-jet ink which is excellent in handling properties, odor, safety, and dispersion stability of a coloring particulate, and which shows no paper-dependency, manifests excellent color developing property and hue when printed on any type of paper, and has various excellent properties. In the ink-jet ink, a coloring composition containing a coloring particulate containing an ionic-group-containing polymer, an oil-soluble dye, and a hydrophobic high-boiling-point organic solvent having a boiling point of at least 150° C., the coloring particulate being dispersed in a water-based medium, wherein content of the hydrophobic high-boiling-point organic solvent in the coloring composition is at least 25% by mass and not more than 95% by mass with respect to a total amount of the ionic-group-containing polymer, the oil-soluble dye, and the hydrophobic high-boiling-point organic solvent.

### BACKGROUND OF THE INVENTION

1. Field of the Invention

The present invention relates to a coloring composition, an ink-jet ink containing the coloring composition and an ink-jet recording method using the same, and more particularly to a coloring composition which has excellent color reproducibility and is suitable for a water-based ink for writing, water-based printing ink, information recording ink and the like, and for an ink-jet ink and an ink-jet recording method suitable for a thermal, piezoelectric, electric field or acoustic ink-jet method.

2. Description of the Related Art

Recently, with the spread of computers, ink-jet printers are widely used for printing paper, film, cloth and the like not only in offices but also in the home. As ink-jet ink, oil-based, water-based and solid inks are known, and water-based ink is mainly used from the standpoints of production, handling properties, odor, safety and the like. However, most of the above-mentioned water-based inks have a problem in that they manifest poor water resistance and cause bleeding, which greatly lowers printing quality, when printed on so called normal paper since these inks use a water-soluble dye which is dissolved in a molecular state, and a problem in that they show poor light resistance, though they have merits of high transparency and high color concentration.

For solving the above-described problems, water-based inks using a pigment and dispersing dye are suggested, for example, in Japanese Patent Application Laid-Open (JP-A) Nos. 56-157468, 4-18468, 8-183920,10-110126, 10-195355 and the like. However, in the case of these water-based inks, there are problems that water resistance is still in sufficient, although it is improved to a certain extent, storage stability of a pigment and a dispersion of a dispersing dye in the water-based ink are deficient, clogging tends to occur at an ink discharge port, and the like. Further, in these water-based inks, since hue is not sufficient, particularly hue of a magenta component is not sufficient in general, there is a problem with color reproducibility based on insufficient hue.

Further, recently, recording paper carrying on the surface thereof an ink receiving layer containing a porous inorganic pigment for obtaining high image quality (called photo quality paper) may sometimes be used in an ink-jet recording method. However, with the above-mentioned water-based ink using a pigment and a dispersing dye, there are problems in that sinking into the above-mentioned photo quality paper is poor, and when the formed image is rubbed with a hand, pigment and dye tend to be peeled from the surface.

Japanese Patent Application Laid-Open (JP-A) Nos. 58-45272, 6-340835, 7-268254, 7-268257 and 7-268260 suggest a method in which dye is contained in a polyurethane or polyester particulate. However, the dispersions described in these publications have a problem that sufficient dispersion stability is not obtained when a dye of desired concentration is contained in the particulate. Further, the peeling problem occurring when the above-mentioned photo quality paper is used has not been solved yet.

On the other hand, JP-A No. 11-286637 suggests a method in which a dye is contained in a condensation-type polymer (polyurethane and the like) mainly having a ionic group, and describes that a solvent having a higher boiling point (water-soluble or water-insoluble) may be present. However, there is only disclosed a water-insoluble hydrophobic solvent having a higher boiling point used in an extremely small amount, among solvents having higher boiling points, and the problem of peeling of dye when used in the above-mentioned photo quality paper can not be solved.

Further, JP-A No. 10-279873 discloses a method in which an acrylic polymer and an oil-soluble dye are dissolved in an organic solvent, and the organic solvent is removed after dispersion, to produce a polymer coloring particulate. However, there are problems in recorded image quality, particularly recorded image quality when recorded on a photo quality paper medium, and in stability in continuous recording. Further, under current conditions, stability with the passing of time of a dispersion is also not sufficient.

### SUMMARY OF THE INVENTION

An object of the present invention is to provide a coloring composition which is excellent in handling properties, odor, safety, and dispersion stability of a coloring particulate, shows no paper-dependency, manifests excellent color developing property and hue when printed on any type of paper, and at the same time has excellent water resistance, light resistance and permeability into a receiving material, leaves no stain directly after printing, provides excellent stability of dye with the lapse of time, and is suitable for water-based ink for writing, water-based printing ink, information recording ink and the like. A further object of the present invention is to provide an ink-jet ink and an ink-jet recording method which are suitable for a thermal, piezoelectric or acoustic ink-jet method, prevent deposition of a dye with the passing of time, cause no clogging at the tip of a nozzle when printing are conducted using a nozzle or the like, even after a period of time, have no paper-dependency, provide excellent recording concentration and hue when printed on any type of paper and excellent ink permeability into photo quality paper, prevent staining directly after printing, and also are excellent in water resistance and light resistance.

Means for solving the above-mentioned problems are as follows.

A first aspect of the present invention is an ink-jet ink comprising a coloring composition containing a coloring particulate containing an ionic-group-containing polymer, an oil-soluble dye, and a hydrophobic high-boiling-point organic solvent having a boiling point of at least 150° C., the coloring particulate being dispersed in a water-based medium, wherein content of the hydrophobic high-boiling-point organic solvent in the coloring composition is at least 25% by mass and not more than 95% by mass with respect to a total amount of the ionic-group-containing polymer, the oil-soluble dye, and the hydrophobic high-boiling-point organic solvent.

A second aspect of the present invention is a coloring composition comprising a coloring particulate containing an ionic-group-containing polymer, an oil-soluble dye, and a hydrophobic high-boiling-point organic solvent having a boiling point of at least 150° C., the coloring particulate being dispersed in a water-based medium, wherein content of the hydrophobic high-boiling-point organic solvent in the coloring composition is at least 25% by mass and not more than 95% by mass with respect to a total amount of the ionic-group-containing polymer, the oil-soluble dye, and the hydrophobic high-boiling-point organic solvent.

A third aspect of the present invention is an ink-jet recording method in which recording is conducted using an ink-jet ink on a recording material, the ink comprising a coloring composition containing a coloring particulate containing an ionic-group-containing polymer, an oil-soluble dye, and a hydrophobic high-boiling-point organic solvent having a boiling point of at least 150° C., the coloring particulate being dispersed in a water-based medium, wherein content of the hydrophobic high-boiling-point organic solvent in the coloring composition is at least 25% by mass and not more than 95% by mass with respect to a total amount of the ionic-group-containing polymer, the oil-soluble dye, and the hydrophobic high-boiling-point organic solvent.

A fourth aspect of the present invention is an ink-jet recording method comprising the step of:

(a) preparing an ink-jet ink, containing coloring composition in which coloring particulate containing an ionic-group-containing polymer, an oil-soluble dye, and a hydrophobic high-boiling-point organic solvent are dispersed in an aqueous medium, with the content of the hydrophobic high-boiling-point organic solvent in the coloring composition being at least 25% by mass and not more than 95% by mass with respect to a total amount of the ionic-group-containing polymer, the oil-soluble dye, and the hydrophobic high-boiling-point organic solvent,

(b) disposing the ink-jet ink in a cartridge adapted for use in an ink-jet printer, and

(c) using the cartridge in an ink jet printer for recording images.

### DESCRIPTION OF THE PREFERRED EMBODIMENTS

(Coloring composition)

A coloring composition of the present invention is prepared by dispersing into a water-based medium a coloring particulate containing an ionic-group-containing polymer, an oil-soluble dye, and a hydrophobic high-boiling-point organic solvent having a boiling point of 150° C. or more.

—Oil-soluble dye—

Of oil-soluble dyes usable in the present invention, any yellow dye can be used. For example, there can be used aryl or heterylazo dyes having phenols, naphthols, anilines, pirazolones, pyridones or opened-type active methylene compounds as a coupling component; azomethine dyes having opened-type active methylene compounds as a coupling component; methine dyes such as benzylidene dyes, monomethineoxonol dyes and the like, for example; quinone-based dyes such as naphthoquinone dyes, anthraquinone dyes and the like; and other compound. Additionally, dyes such as quinophthalone dyes, nitro·nitroso dyes, acrydine dyes, acrydinone dyes and the like can also be used.

Of oil-soluble dyes usable in the present invention, any magenta dye can be used. For example, there can be used aryl or heterylazo dyes having phenols, naphthols or anilines as a coupling component; azomethine dyes having pyrazolones or pyrazolotriazoles as a coupling component; methine dyes such as arylidene dyes, styryl dyes, merocyanine dyes or oxonol dyes; carbonium dyes such as diphenylmethane dyes, triphenylmethane dyes or xanthene dyes; quinone-based dyes such as naphthoquinone, anthraquinone, anthrapyridone and the like; condensed polycyclic dyes such as dioxazine dyes and the like; and other compounds.

Of oil-soluble dyes usable in the present invention, any cyan dye can be used. For example, there can be used azomethine dyes such as indoaniline dyes or indophenol dyes; polymethine dyes such as cyanine dyes, oxonol dyes, merocyanine dyes and the like; carbonium dyes such as diphenylmethane dyes, triphenylmethane dyes or xanthene dyes; phthalocyanine dyes; anthraquinone dyes; aryl or heterylazo dyes having phenols, naphthols or anilines as a coupling component; indigo·thioindigo dyes; and the like.

Though the above-mentioned each dye has a chromophore in the structure, there can also be used, in the present invention, dyes which do not develop color (yellow, magenta, cyan or the like) until decomposition of a part of the chromophore. As a counter cation to be decomposed, inorganic cations such as cations of alkali metals, ammonium ions and the like may be used, or organic cations such as pyridinium ions, quaternary ammonium ions and the like may be used and, further, polymer cations containing these cations as a part of the structure may also be used.

Specific examples of the oil-soluble dye include, but are not limited to, C.I. Solvent Black 3, 7, 27, 29 and 34; C.I. Solvent Yellow 14, 16, 19, 29, 30, 56, 82, 93 and 162; C.I. Solvent Red 1, 3, 8, 18, 24, 27, 43, 49, 51, 72, 73, 109, 122, 132 and 218; C.I. Solvent Violet 3; C.I. Solvent Blue 2, 11, 25, 35 and 70; C.I. Solvent Green 3 and 7; and C.I. Solvent Orange 2, and the like. Of these, particularly preferable are Nubian Black PC-0850, Oil Black HBB, Oil Yellow 129, Oil Yellow 105, Oil Pink 312, Oil Red 5B, Oil Scarlet 308, Vali Fast Blue 2606, Oil Blue BOS (manufactured by Orient Kagaku K. K.), Neopen Yellow 075, Neopen Magenta SE 1378, Neopen Blue 808, Neopen Blue FF 4012, Neopen Cyan FF 4238 (manufactured by BASF) and the like.

In the present invention, a dispersing dye can be used in an amount such that the dispersing dye is dissolved in a non-water miscible organic solvent, and preferable specific examples thereof include C.I. Disperse Yellow 5, 42, 54, 64, 79, 82, 83, 93, 99, 100, 119, 122, 124, 126, 160, 184:1, 186, 198, 199, 201, 204, 224 and 237; C.I. Disperse Orange 13, 29, 31:1, 33, 49, 54, 55, 66, 73, 118, 119 and 163; C.I. Disperse Red 54, 60, 72, 73, 86, 88, 91, 92, 93, 111, 126, 127, 134, 135, 143, 145, 152, 153, 154, 159, 164, 167, 177, 181, 204, 206, 207, 221, 239, 240, 258, 277, 278, 283, 311, 323, 343, 348, 356 and 362; C.I. Disperse Violet 33; C.I. Disperse Blue 56, 60, 73, 87, 113, 128, 143, 148, 154, 158, 165, 165:1, 165:2, 176, 183, 185, 197, 198, 201, 214, 224, 225, 257, 266, 267, 287, 354, 358, 365 and 368; C.I. Disperse Green 6:1 and 9; and the like.

Of these, the above-mentioned oil-soluble dye is preferably a dye produced from a developing agent and a coupler by oxidation, the dye being utilized as a color photography material and, among others, dyes represented by the general formula (I) are preferable. Hereafter, the dye represented by the general formula (I) will be illustrated, and dyes in which at least one of groups in the general formula (I) is a group included in a preferable range shown below are preferable, and dyes in which more groups are in a preferable range are more preferable, and those in which all groups are in a preferable range are most preferable.

general formula (I)

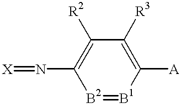

In the above-mentioned general formula (I), X represents a residual group of a color coupler, A represents —NR⁴R⁵ or a hydroxy group, R⁴ and R⁵ each independently represents a hydrogen atom, aliphatic group, aromatic group or heterocyclic group. A is preferably —NR⁴R⁵. R⁴ and R⁵ each independently represents preferably a hydrogen atom or aliphatic group, and further preferably a hydrogen atom, alkyl group or substituted alkyl group, and most preferably a hydrogen atom, an alkyl group having 1 to 18 carbon atoms or a substituted alkyl group having 1 to 18 carbon atoms.

In the above-described formula (I), B¹ represents ═C(R⁶)— or ═N—, and B² represents —C(R⁷)═ or —N═. It is preferable that B¹ and B² do not simultaneously represent —N═, and it is more preferable that B¹ represents ═C(R⁶)— and B² represents —C(R⁷)═.

In the general formula (I), R², R³, R⁶ and R⁷ each independently represents a hydrogen atom, halogen atom, aliphatic group, aromatic group, heterocyclic group, cyano group, —OR⁵¹, —SR⁵², —CO₂R⁵³, —OCOR⁵⁴, —NR⁵⁵R⁵⁶, —CONR⁵⁷R⁵⁸, —SO₂R⁵⁹, SO₂NR⁶⁰R⁶¹, —NR⁶²CONR⁶³R⁶⁴, NR⁶⁵CO₂R⁶⁶, —COR⁶⁷, NR⁶⁸COR⁶⁹ or —NR⁷⁰SO₂R⁷¹, and R⁵¹, R⁵², R⁵³, R⁵⁴, R⁵⁵, R⁵⁶, R⁵⁷, R⁵⁸, R⁵⁹, R⁶⁰, R⁶¹, R⁶², R⁶³, R⁶⁴, R⁶⁵, R⁶⁶, R⁶⁷, R⁶⁸, R⁶⁹, R⁷⁰, and R⁷¹ each independently represents a hydrogen atom, aliphatic group or aromatic group.

R² and R⁷ each independently represents, among the above-mentioned moieties, preferably a hydrogen atom, halogen atom, aliphatic group, —OR⁵¹, —NR⁶²CONR⁶³R⁶⁴, —NR⁶⁵CO₂R⁶⁶, —NR⁶⁸COR⁶⁹, or —NR⁷⁰SO₂R⁷¹, further preferably a hydrogen atom, fluorine atom, chlorine atom, alkyl group, substituted alkyl group, —NR⁶²CONR⁶³R⁶⁴, or —NR⁶⁸COR⁶⁹, still further preferably a hydrogen atom, chlorine atom, alkyl group having 1 to 10 carbon atoms, or substituted alkyl group having 1 to 10 carbon atoms, and most preferably a hydrogen atom, alkyl group having 1 to 4 carbon atoms, or substituted alkyl group having 1 to 4 carbon atoms.

R³ and R⁶ each independently represents, among the above-mentioned moieties, preferably a hydrogen atom, halogen atom, or aliphatic group, further preferably a hydrogen atom, fluorine atom, chlorine atom, alkyl group, or substituted alkyl group, still further preferably a hydrogen atom, chlorine atom, alkyl group having 1 to 10 carbon atoms, or substituted alkyl group having 1 to 10 carbon atoms, and most preferably a hydrogen atom, alkyl group having 1 to 4 carbon atoms, or substituted alkyl group having 1 to 4 carbon atoms.

In the general formula (I), R² and R³, R³ and R⁴, R⁴ and R⁵, R⁵ and R⁶, or R⁶ and R⁷ may bond with each other to form rings. As a combination to form rings, combinations of R³ and R⁴, R⁴ and R⁵, and R⁵ and R⁶ are preferable. A ring formed by mutual bonding of R² and R³, or R⁶ and R⁷ is preferably a 5-member ring or 6-member ring. The ring is preferably an aromatic ring (for example, a benzene ring) or an unsaturated heterocyclic ring (for example, a pyridine ring, imidazole ring, thiazole ring, pyrimidine ring, pyrrole ring, or furan ring). A ring formed by mutual bonding of R³ and R⁴, or R⁵ and R⁶ is preferably a 5-member ring or 6-member ring. Examples of the ring include a tetrahydroquinoline ring and dihydroindole ring. A ring formed by mutual bonding of R⁴ and R⁵ is preferably a 5-member ring or 6-member ring. Examples of the ring include a pyrrolidine ring, piperidine ring and morpholine ring.

In the present specification, aliphatic group means an alkyl group, substituted alkyl group, alkenyl group, substituted alkenyl group, alkinyl group, substituted alkinyl group, aralkyl group or substituted aralkyl group.

The alkyl group may have branching, or may form a ring. The number of carbon atoms in the alkyl group is preferably from 1 to 20, and further preferably from 1 to 18.

An alkyl moiety of the substituted alkyl group is the same as in the above-mentioned alkyl group.

The alkenyl group may have branching, or may form a ring. The number of carbon atoms in the alkenyl group is preferably from 2 to 20, and further preferably from 2 to 18.

An alkenyl moiety of the substituted alkenyl group is the same as in the above-mentioned alkenyl group.

The alkinyl group may have branching, or may form a ring. The number of carbon atoms in the alkinyl group is preferably from 2 to 20, and further preferably from 2 to 18.

An alkinyl moiety of the substituted alkinyl group is the same as in the above-mentioned alkinyl group.

An alkyl moiety of the aralkyl group and substituted aralkyl group is the same as in the above-mentioned alkyl group. An aryl moiety of the aralkyl group and substituted aralkyl group is the same as in the following aryl group

Examples of substituents on the substituted alkyl group, substituted alkenyl group, substituted alkinyl group and substituents on an alkyl moiety of the substituted aralkyl group include a halogen atom, cyano group, nitro group, heterocyclic group, —OR¹¹¹, —SR¹¹², —CO₂R¹¹³, —NR¹¹⁴R¹¹⁵, —CONR¹¹⁶R¹¹⁷, —SO₂R¹¹⁸, and —SO₂NR¹¹⁹R¹²⁰. R¹¹¹, R¹¹², R¹¹³, R¹¹⁴, R¹¹⁵, R¹¹⁶, R¹¹⁷, R¹¹⁸, R¹¹⁹ and R¹²⁰ each independently represents a hydrogen atom, aliphatic group or aromatic group.

Examples of substituents on an aryl moiety of the substituted aralkyl group are the same as the following examples of substituents on the substituted aryl group.

In the present specification, aromatic group means an aryl group or substituted aryl group. The aryl group is preferably a phenyl group or naphthyl group, and particularly preferably a phenyl group.

An aryl moiety of the substituted aryl group is the same as in the above-mentioned aryl group.

Examples of substituents on the substituted aryl group include a halogen atom, cyano group, nitro group, aliphatic group, heterocyclic group, —OR¹²¹, —SR¹²², —CO₂R¹²³, —NR¹²⁴R¹²⁵, —CONR¹²⁶R¹²⁷, —SO₂R¹²⁸, and SO₂NR¹²⁹R¹³⁰. R¹²¹, R¹²², R¹²³, R¹²⁴, R¹²⁵, R¹²⁶, R¹²⁷, R¹²⁸, R¹²⁹ and R¹³⁰ each independently represents a hydrogen atom, aliphatic group or aromatic group.

In the present specification, the heterocyclic group includes both of groups having a saturated ring and groups having an unsaturated ring. The heterocyclic ring is preferably a 5-member or 6-member ring. Further, the heterocyclic ring may be condensed with an aliphatic ring, aromatic ring or other heterocyclic ring. The hetero atom in the heterocyclic ring includes B, N, O, S, Se and Te. Of these, the hetero atom is preferably N, O or S. A heterocyclic group in which a carbon atom, among atoms constituting the heterocyclic ring, has free atomic valency (monovalency) is preferable (a heterocyclic group is bonded at a carbon atom). Examples of the saturated heterocyclic ring include a pyrrolidine ring, morpholine ring, 2-bora-1,3-dioxorane ring and 1,3-thiazolidine ring. Examples of the unsaturated heterocyclic ring include an imidazole ring, thiazole ring, benzothiazole ring, benzooxazole ring, banzotriazole ring, benzoselenazole ring, pyridine ring, pyrimidine ring and quinoline ring.

The heterocyclic group may have a substituent. Examples of this substituent include a halogen atom, cyano group, nitro group, aliphatic group, aromatic group, heterocyclic group, —OR¹³¹, —SR¹³², —CO₂R¹³³, —NR¹³⁴R¹³⁵, —CONR¹³⁶R¹³⁷, —SO₂R¹³⁸, and —SO₂NR¹³⁹R¹⁴⁰. R¹³¹, R¹³², R¹³³, R¹³⁴, R¹³⁵, R¹³⁶ R¹³⁷, R¹³⁸, R¹³⁹, and R¹⁴⁰ each independently represents a hydrogen atom, aliphatic group or aromatic group.

In the above-mentioned general formula (I), X represents a residual group of a color coupler. A pigment represented by the general formula (I) is produced by reacting an oxide of a developing agent with a coupler, and X represents a group derived from the coupler. Herein, the coupler is a compound which can cause a coupling reaction with an oxide of a developing agent. More specific explanations thereof are described in “3.6, Kapura to Kanren Busshitsu” (Couplers and Related substances), pp. 204 to 222 in “Shashin Kogaku no Kiso-Ginen Shashin Hen” (Base of Photography Technology Silver Salt Photography Chapter) (edited by Nihon Shashin Gakkai (Japan Photography Institution)) (1979, issued by Corona K. K.). Here, the developing agent is a compound whose oxide can cause a coupling reaction with a coupler to form a cyan, magenta or yellow azomethine pigment, indoaniline pigment or the like. Examples include p-phenylenediamine derivatives, p-aminophenol derivatives and the like (preferably, p-phenylenediamine derivatives). More specific explanations thereof are described in “4.3, Kara Shashin no Genzo Shori” (Developing Treatment of Color Photography), pp. 345 to 354 in “Shashin Kogaku no Kiso-Ginen Shashin Hen” (Base of Photography Technology-Silver Salt Photography Chapter) (edited by Nihon Shashin Gakkai (Japan Photography Institution)) (1979, issued by Corona K. K.).

As the yellow coupler, examples include couplers represented by the formulae (I) and (II) described in U.S. Pat. Nos. 3,933,501, 4,022,620, 4,326,024, 4,401,752 and 4,248,961, Japanese Patent Application Publication (JP-B) No. 58-10739, GB Patent Nos. 1,425,020 and 1,476,760, U.S. Pat. Nos. 3,973,968, 4,314,023 and 4,511,649, EU Patent Nos. 249,473A and 502,424A, couplers represented by the formulae (1) and (2) described in EU Patent No. 513,496A (particularly Y-28 described on page 18), couplers represented by the formula (1) described in claim 1 of EU Patent No. 568,037A, couplers represented by the general formula (1) described in U.S. Pat. No. 5,066,576, column 1, line 45 to 55, couplers represented by the general formula (1) described in JP-A No. 4-274425, paragraph 0008, couplers represented by the formula (1) described in EU Patent No. 498,381A1, p. 40, claim 1 (particularly D-35 described on page 18), couplers represented by the formula (Y) described in EU Patent No. 447,969A, p. 4 (particularly Y-1 (page 17) and Y-54 (page 41)) and couplers represented by the formulae (II) to (IV) described in U.S. Pat. No. 4,476,219, column 7, line. 36 to 58 (particularly II-17, 19 (column 17) and II-24 (column 19)).

As the magenta coupler, there are listed compounds described in U.S. Pat. Nos. 4,310,619 and 4,351,897, EU Patent No. 73,636, U.S. Pat. Nos. 3,061,432, 3,725,067, Research Disclosure Nos. 24220 (June 1984) and 24230 (June 1984), JP-A Nos. 60-33552, 60-43659, 61-72238, 60-35730, 55-118034 and 60-185951, U.S. Pat. Nos. 4,500,630, 4,540,654 and 4,556,630, International publication WO 88/04795, JP-A Nos. 3-39737 (L-57 (page 11, lower right column), L-68 (page 12, lower right column, L-77 (page 13, lower right column), [A-4 -63 (page 134), [A-4]-73, -75 (page 139) described in EU Patent No. 456,257, M-4, -6 (page 26), M-7 (page 27) described in EU Patent No. 486, 965, M-458 (page 19) described in EU Patent No. 486,959A, (M-1) described in JP-A No. 5-204106 (page 6), M-22 described in JP-A No. 4-362631, paragraph 0237.

As the cyan coupler, there are listed compounds described in U.S. Pat. Nos. 4,052,212, 4,146,396, 4,228,233 and 4,296,200, EU Patent No. 73,636, and CX-1, 3, 4, 5, 11, 12, 14, and 15 (pages 14 to 16) described in JP-A No. 4-204843; C-7, 10 (page 35), 34, 35 (page 37), I-1, I-17 (pages 42 to 43) described in JP-A No. 4-43345; and couplers represented by the general formula (Ia) or (Ib) described in JP-A No. 6-67385, claim 1.

In addition, couplers described in JP-A Nos. 62-215227 (page 91) and 2-33144 (pages 3, 30) and EP 355,660A (pages 4, 5, 45, 47) are also useful.

Of compounds represented by the above-mentioned general formula (I), compounds represented by the following general formula (II) are particularly preferably used as the magenta dye.

General formula (II)

[chemical structure]

In the general formula (II), R¹ represents a hydrogen atom, aliphatic group, aromatic group, heterocyclic group, cyano group, —OR¹¹, —SR¹², —CO₂R¹³, —OCOR¹⁴, NR¹⁵R¹⁶, —CONR¹⁷R¹⁸, —SO₂R¹⁹, —SO₂NR²⁰R²¹, —NR²²CONR²³R²⁴, —NR²⁵CO₂R²⁶, —COR²⁷, —NR²⁸COR²⁹, or —NR³⁰SO₂R³¹, and R¹¹, R¹², R¹³, R¹⁴, R¹⁵, R¹⁶, R¹⁷, R¹⁸, R¹⁹, R²⁰, R²¹, R²², R²³, R²⁴, R²⁵, R²⁶, R²⁷, R²⁸, R²⁹, R³⁰, and R³¹ each independently represents a hydrogen atom, aliphatic group or aromatic group. R², R³, A, B¹ and B² are as defined in the formula (I), and preferable ranges thereof are the same.

In the above-mentioned general formula (II), D represents a group of atoms forming a 5-member or 6-member nitrogen-containing heterocyclic ring which may be substituted by at least one of an aliphatic group, aromatic group, heterocyclic group, cyano group, —OR⁸¹, —SR⁸², —CO₂R⁸³, —OCOR⁸⁴, —NR⁸⁵R⁸⁶, —CONR⁸⁷R⁸⁸, —SO₂R⁸⁹, —SO₂NR⁹⁰R⁹¹, —NR⁹²CONR⁹³R⁹⁴, —NR⁹⁵CO₂R⁹⁶, —COR⁹⁷, —NR⁹⁸COR⁹⁹, or —NR¹⁰⁰SO₂R¹⁰¹, and this heterocyclic ring may further form a condensed ring with other ring. Here, R⁸¹, R⁸², R⁸³, R⁸⁴, R⁸⁵, R⁸⁶, R⁸⁷, R⁸⁸, R⁸⁹, R⁹⁰, R⁹¹, R⁹², R⁹³, R⁹⁴, R⁹⁵, R⁹⁶, R⁹⁷, R⁹⁸, R⁹⁹, R¹⁰⁰, and R¹⁰¹ each independently represents a hydrogen atom, aliphatic group or aromatic group.

Of compounds represented by the general formula (II), those in which A is —NR⁴R⁵ are further preferable.

Next, the general formula (II) will be described in further in detail. R¹ represents, of the above-mentioned groups, preferably a hydrogen atom, aliphatic group, aromatic group, —OR¹¹, —SR¹², —NR¹⁵R¹⁶, —SO₂R¹⁹, —NR²²CONR²³R²⁴, —NR²⁵CO₂R²⁶, —NR²⁸COR²⁹, or —NR³⁰SO₂R³¹, more preferably a hydrogen atom, aliphatic group, aromatic group, —OR¹¹, or —NR¹⁵R¹⁶, still more preferably a hydrogen atom, alkyl group, substituted alkyl group, aryl group, substituted aryl group, alkoxy group, substituted alkoxy group, phenoxy group, substituted phenoxy group, dialkylamino group, or substituted dialkylamino group, further preferably a hydrogen atom, alkyl group having 1 to 10 carbon atoms, substituted alkyl group having 1 to 10 carbon atoms, aryl group having 6 to 10 carbon atoms or substituted aryl group having 6 to 10 carbon atoms, and most preferably a hydrogen atom, alkyl group having 1 to 6 carbon atoms, or substituted alkyl group having 1 to 6 carbon atoms.

D preferably forms a 5-member nitrogen-containing heterocyclic ring, and examples of the 5-member nitrogen-containing heterocyclic ring include an imidazole ring, triazole ring and tetrazole ring.

Of compounds represented by the above-mentioned general formula (II), pyrazolotriazoleazomethine compounds represented by the following general formula (III) are preferable.

General formula (III)

[chemical structure]

In this formula, R¹, R², R³, R⁴, R⁵, R⁶ and R⁷ have the same definitions as in the above-mentioned general formula (II). X¹ and Y each independently represents —C(R⁸)═ or —N═, R⁸ represents a hydrogen atom, aliphatic group or aromatic group, one of X¹ and Y is necessarily —N═, and X¹ and Y do not simultaneously represent —N═.

Here, R⁸ represents preferably a hydrogen atom, alkyl group, substituted alkyl group, aryl group, or substituted aryl group, further preferably a hydrogen atom, alkyl group having 1 to 150 carbon atoms, or substituted aryl group having 6 to 150 carbon atoms, and most preferably an alkyl group having 1 to 100 carbon atoms, or substituted aryl group having 6 to 100 carbon atoms.

Of compounds represented by the above-mentioned general formula (III), pyrazolotriazoleazomethine compounds in which X represents —N═, and Y represents —C(R⁸)═ are more preferable.

Exemplified compounds (M-1 to 16) of the pyrazolotriazoleazomethine compound represented by the general formula (II) are listed below.

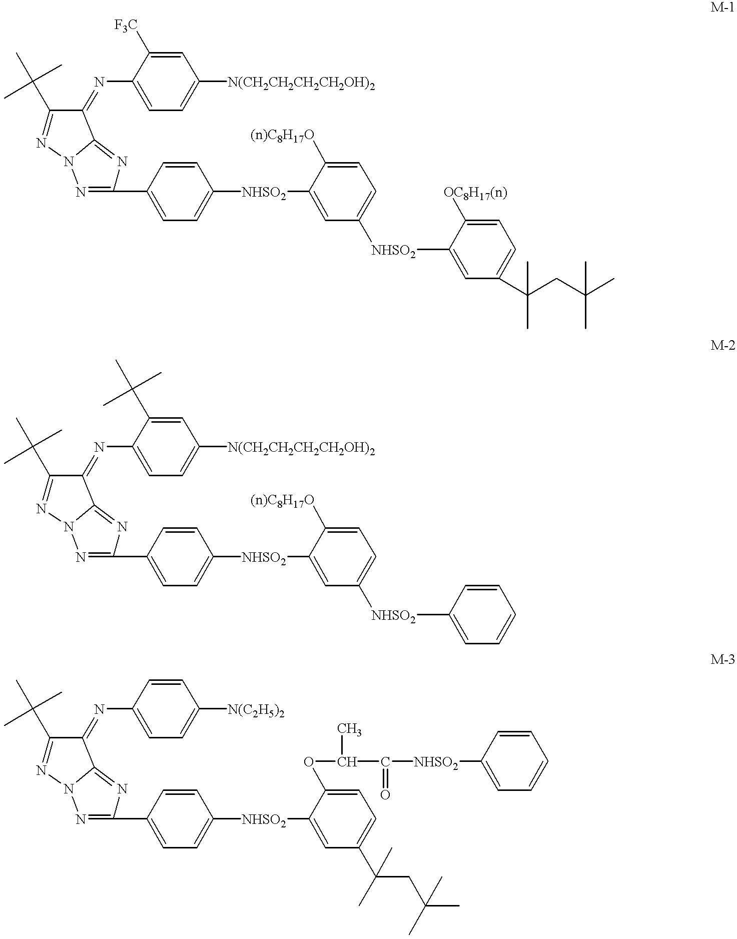

Examples of compounds usable in the present invention include, but are not limited to, exemplified compounds described in Japanese Patent Application No. 11-365189.

The pigment represented by the general formula (II) can be synthesized, for example, by referring to methods described in JP-A No. 4-126772, Japanese Patent Application Publication (JP-B) No. 7-94180 and Japanese Patent Application No. 11-365187.

As the cyan dye, pyrrolotriazoleazomethine compounds represented by the following formulae (IV-1) to (IV-4) are particularly preferably used.

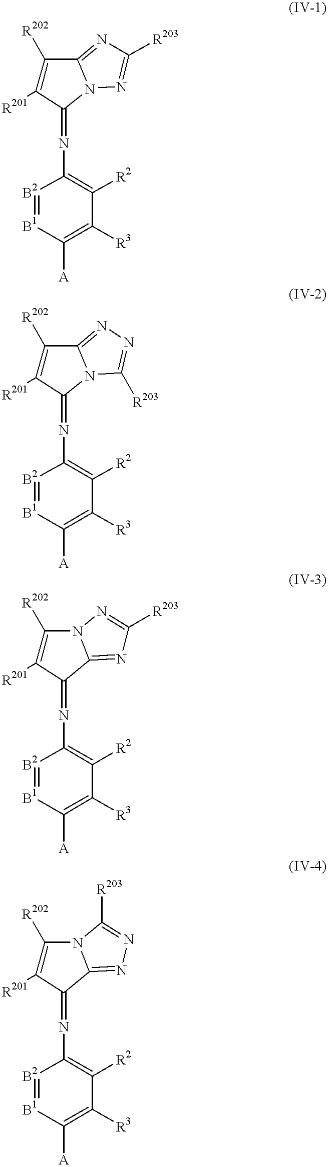

In the formulae (IV-1) to (IV-4), A, R², R³, B¹ and B² have the same definitions as in the formula (I), and preferable ranges thereof are the same. R²⁰¹, R²⁰² and R²⁰³ each independently has the same definition as R¹ in the formula (II). R²⁰¹ and R²⁰² may bond mutually to form a ring structure.

Further, pyrrolotriazoleazomethine compounds represented by the formulae (IV-1) to (IV-4) in which R²⁰¹ is an electron attractive group having Hammett substituent constant σ_{P} value of 0.30 or more manifest sharp absorption and are more preferable. Pyrrolotriazoleazomethine compounds in which the sum of Hammett substituent constant σ_{P} values of R²⁰¹ and R²⁰² is 0.70 or more manifest excellent hue as cyan color, and are further preferable.

Further detailed explanations will be made on hue. Pyrrolotriazoleazomethine compounds represented by the formulae (IV-1) to (IV-4) manifest various hues depending on combination of R²⁰¹, R²⁰², R²⁰³ and R², R³, A, B¹ and B². Pyrrolotriazoleazomethine compounds represented by the formulae (IV-1) to (IV-4) in which R²¹⁰ is a substituent having electron attractive property manifest more sharp absorption wave form and are preferable as compared with compounds in which R²⁰¹ is not an electron attractive substituent. When the electron attractive property is higher, the absorption wave form is more sharp. In this point, it is more preferable that R²⁰¹ is an electron attractive group having a Hammett substituent constant σ_{P} value of 0.30 or more than that R²⁰¹ is an alkyl group or aryl group. Further, an electron attractive group having a Hammett substituent constant σ_{P} value of 0.45 or more is more preferable, and the same having a Hammett substituent constant σ_{P} value of 0.60 or more is most preferable.

The above-mentioned pyrrolotriazoleazomethine compound can be used as a magenta pigment or cyan pigment. It is more preferable to use this compound as a cyan pigment. Further, pyrrolotriazoleazomethine compounds represented by the formulae (IV-1) to (IV-4) can also be used as a magenta pigment. For use of pyrrolotriazoleazomethine compounds represented by the formulae (IV-1) to (IV-4) as a cyan pigment, it is preferable that the sum of Hammett substituent constant σ_{P} values of R²⁰¹ and R²⁰² is 0.70 or more. When this sum is less than 0.70, the absorption maximum wavelength is short for a cyan pigment, undesirably. Among others, those in which R²⁰² has a Hammett substituent constant σ_{P} value of 0.30 or more are preferable. The sum of Hammett substituent constant σ_{P} values of R²⁰¹ and R²⁰² is preferably 2.0 or less.

As the electron attractive group having a Hammett substituent constant σ_{P} value of 0.30 or more, there are listed acyl groups, acyloxy groups, carbamoyl groups, alkoxycarbonyl groups, aryloxycarbonyl groups, cyano groups, nitro groups, alkylsulfinyl groups, arylsulfinyl groups, alkylsulfonyl groups, arylsulfonyl groups, sulfamoyl groups, halogenated alkyl groups, halogenated alkoxy groups, halogenated aryloxy groups, halogenated alkylthio groups, aryl groups substituted with two or more electron attractive groups having a σ_{P} value of 0.15 or more, and heterocyclic rings. More specifically, there are listed acyl groups (for example, acetyl, 3-phenylpropanoyl), acyloxy groups (for example, acetoxy), canbamoyl groups (for example, N-ethylcarbamoyl, N,N-dibutylcarbamoyl, N-(2-dodecyloxyethyl)carbamoyl, N-methyl-N-dodecylcarbamoyl), alkoxycarbonyl groups (for example, methoxycarbonyl, butyloxycarbonyl, dodecyloxycarbonyl, octadecyloxycarbonyl), aryloxycarbonyl groups (for example, phenoxycarbonyl), cyano groups, nitro groups, alkylsulfinyl groups (for example, 3-phenoxypropylsulfinyl), arylsulfinyl groups (for example, 3-pentadecylphenylsulfinyl), alkylsulfonyl groups (for example, methanesulfonyl, octanesulfonyl), arylsulfonyl groups (for example, benzenesulfonyl), sulfamoyl groups (for example, N-ethylsulfamoyl, N,N-dipropylsulfamoyl), halogenated alkyl groups (for example, trifluoromethyl, heptafluoropropyl), halogenated alkoxy groups (for example, trifluoromethyloxy), halogenated aryloxy groups (for example, pentafluorophenyloxy), halogenated alkylthio groups (for example, difluoromethylthio), aryl groups substituted with two or more electron attractive groups having a σ_{P} value of 0.15 or more (for example, 2,4-dinitrophenyl, 2,4,6-trichlorophenyl, pentachlorophenyl), and heterocyclic rings (for example, 2-benzooxazolyl, 2-benzothiazolyl, 1-phenyl-2-benzimidazolyl, 5-chloro-1-tetrazolyl, 1-pyrrolyl).

As the electron attractive group having a Hammett substituent constant σ_{P} value of 0.45 or more, there are listed acyl groups (for example, acetyl, 3-phenylpropanoyl), alkoxycarbonyl groups (for example, methoxycarbonyl), aryloxycarbonyl groups (for example, m-chlorophenoxycarbonyl), cyano group, nitro group, alkylsulfinyl groups (for example, n-propylsulfinyl), arylsulfinyl groups (for example, phenylsulfinyl), alkylsulfonyl groups (for example, methanesulfonyl and n-octanesulfonyl), arylsulfonyl groups (for example, benzenesulfonyl), sulfamoyl groups (for example, N-ethylsulfamoyl and N,N-dimethylsulfamoyl), and halogenated alkyl groups (for example, trifluoromethyl). As the electron attractive group having a Hammett substituent constant σ_{P} value of 0.60 or more, examples include a cyano group (0.66), nitro group (0.78) and methanesulfonyl group (0.72).

As the combination in which the sum of σ_{P} values of R²⁰¹ and R²⁰² is 0.70 or more, combinations in which R²⁰¹ is selected from cyano groups, alkoxycarbonyl groups, alkylsulfonyl groups, arylsulfonyl groups and halogenated alkyl groups, and R²⁰² is selected from acyl groups, acyloxy groups, carbamoyl groups, alkoxycarbonyl groups, aryloxycarbonyl groups, cyano group, alkylsulfonyl groups, arylsulfonyl groups, sulfamoyl groups and halogenated alkyl groups are preferable.

The pyrrolotriazoleazomethine compound used in the present invention has a preferable structure is selected from compounds represented by the following general formula (IV-1a), in which R² is a hydrogen atom, alkyl group having 1 to 4 carbon atoms, substituted alkyl group having 1 to 4 carbon atoms, alkoxy group having 1 to 4 carbon atoms, halogen atom (fluorine, chlorine, or bromine), acylamino group having 1 to 5 carbon atoms, aminocarbonylamino group having 1 to 5 carbon atoms or alkoxycarbonylamino group having 2 to 5 carbon atoms; R⁴ and R⁵ each independently is a hydrogen atom, alkyl group having 1 to 18 carbon atoms or substituted alkyl group having 1 to 18 carbon atoms; R²⁰¹ and R²⁰² each independently represents an electron attractive group having a Hammett substituent constant σ_{P} value of 0.30 or more, and R²⁰³ is an alkyl group having 1 to 18 carbon atoms, substituted alkyl group having 1 to 18 carbon atoms, or substituted or unsubstituted aryl group having 6 to 20 carbon atoms. When used as a cyan pigment, those of the above-mentioned groups in which the sum of Hammett substituent constant σ_{P} values of R²⁰¹ and R²⁰² is 0.70 or more are preferable, and those in which the sum of σ_{P} values is 1.00 or more are further preferable. The pyrrolotriazoleazomethine compound used in the present invention has a most preferable structure selected from compounds represented by the general formula (IV-1a) in which R² is a hydrogen atom or methyl group; R⁴ and R⁵ each independently is an alkyl group having 1 to 5 carbon atoms; R²⁰¹ is a cyano group; R²⁰² is an alkoxycarbonyl group; and R²⁰³ is an aryl group.

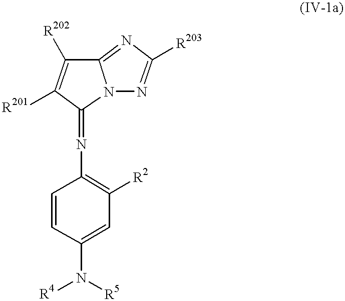

The Hammett substituent constant used in the present specification is described in Japanese Patent Application No. 11-365188, and the σ_{P} value in the present invention is also as defined in the same.

Exemplified compounds (C-1 to 9) of the pyrrolotriazoleazomethine compound used in the present invention will be listed only for illustrating the present invention in detail; however, these compounds do not limit the scope of the present invention.

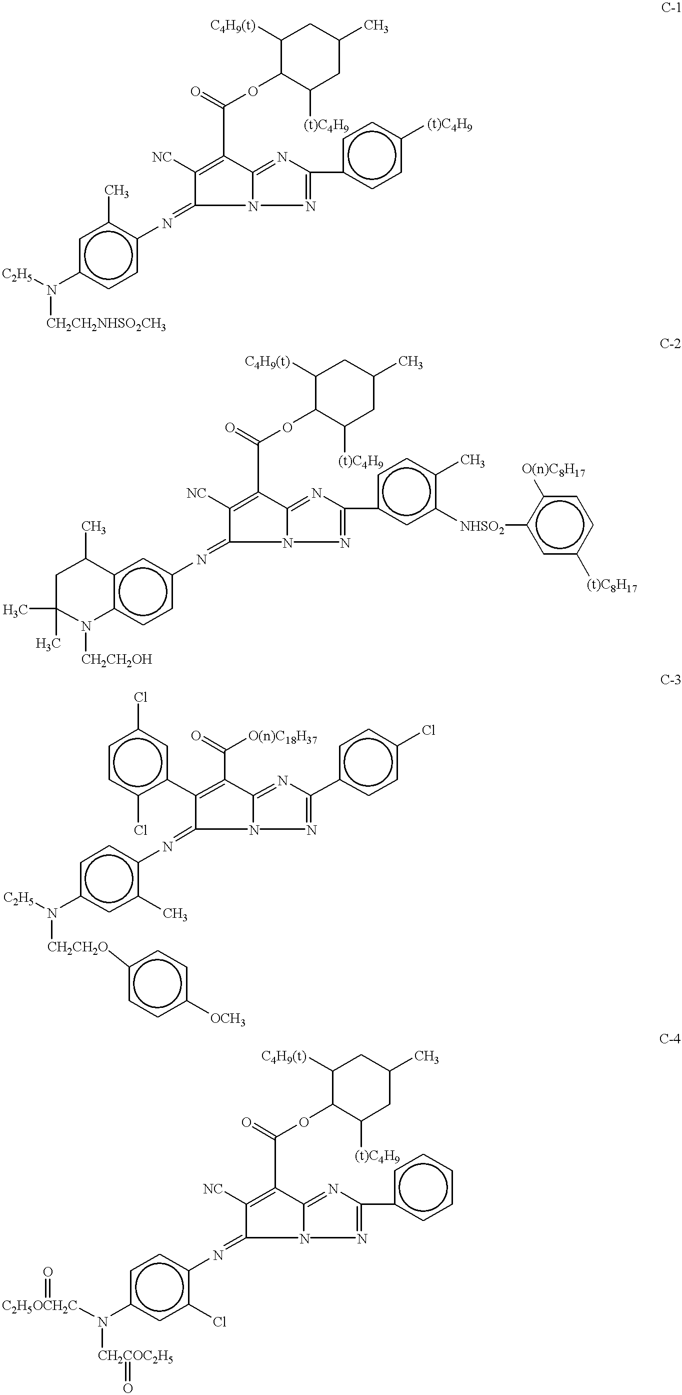

As Compounds usable in the present invention, exemplified compounds described in Japanese Patent Application No. 11-365188 are further listed; however, these compounds do not limit the scope of the present invention.

The pyrrolotriazoleazomethine pigment represented by the general formulae (IV-1) to (IV-4) can be synthesized referring to methods described in JP-A Nos. 5-177959, 9-292679, 10-62926, and Japanese Patent Application No. 11-365188.

—Ionic group-containing polymer—

In the present invention, the ionic-group-containing polymer is a polymer having a cationic group such as a tertiary amino group, or an anionic group of a carboxylic acid, sulfonic acid and the like. As the ionic-group-containing polymer, there are listed, for example, vinyl polymers and condensate polymers (polyurethane, polyester, polyamide, polyurea and polycarbonate). The above-mentioned ionic-group-containing polymer may be any of water-insoluble, water-dispersible (self emulsifying), or water-soluble, and is preferably water-soluble or water-dispersible from the standpoints of production easiness, dispersion stability of a coloring particulate, and the like.

As the vinyl polymer applicable to the ionic-group-containing polymer, there are listed, for example, polymers obtained by polymerizing the following vinyl monomers. Namely, there are listed acrylates and methacrylates (an ester group may be an alkyl group or aryl group that has a substituent; for example, a methyl group, ethyl group, n-propyl group, isopropyl group, n-butyl group, sec-butyl group, tert-butyl group, hexyl group, 2-ethylhexyl group, tert-octyl group, 2-chloroethyl group, cyanoethyl group, 2-acetoxyethyl group, tetrahydrofurfuryl group, 5-hydroxypentyl group, cyclohexyl group, benzyl group, hydroxyethyl group, 3-methoxybutyl group, 2-(2-methoxyethoxy)ethyl group, 2,2,2-tetrafluoroethyl group, 1H, 1H, 2H, 2H-perfluorodecyl group, phenyl group, 2,4,5-tetramethylpheyl group, 4-chlorophenyl group or the like);

vinyl esters: specifically, vinyl aliphatic carboxylates which may have a substituent (for example, vinyl acetate, vinyl propionate, vinyl butyrate, vinyl isobutyrate, vinyl caproate, vinylchloro acetate and the like), vinyl aromatic carboxylates which may have a substituent (for example, vinyl benzoate, vinyl 4-methylbenzoate, vinyl salicylate and the like);

acrylamides: specifically, acrylamide, N-monosubstituted acrylamides, N-disubstituted acrylamides (a substituent is an alkyl group, aryl group or silyl group which may have a substituent; and for example, a methyl group, n-propyl group, isopropyl group, n-butyl group, tert-butyl group, tert-octyl group, cyclohexyl group, benzyl group, hydroxymethyl group, alkoxymethyl group, phenyl group, 2,4,5-tetramethylphenyl group, 4-chlorophenyl group, trimethylsilyl group and the like);

methacrylamides, specifically, methacrylamide, N-monosubstituted methacrylamides, N-disubstituted methacrylamides (a substituent is an alkyl group, aryl group or silyl group which may have a substituent; for example, a methyl group, n-propyl group, isopropyl group, n-butyl group, tert-butyl group, tert-octyl group, cyclohexyl group, benzyl group, hydroxymethyl group, alkoxymethyl group, phenyl group, 2,4,5-tetramethylphenyl group, 4-chlorophenyl group, trimethylsilyl group and the like);

olefins (for example, ethylene, propylene, 1-pentene, vinyl chloride, vinylidene chloride, isoprene, chloroprene, butadiene and the like), styrenes (for example, styrene, methylstyrene, isopropylsytrene, methoxystyrene, acetoxystyrene, chlorostyrene and the like), vinyl ethers (for example, methyl vinyl ether, butyl vinyl ether, hexyl vinyl ether, methoxyethyl vinyl ether and the like); and other compounds.

As the other vinyl monomer, examples include listed crotonate esters, itaconate esters, maleate diesters, fumarate diesters, methyl vinyl ketone, phenyl vinyl ketone, methoxyethyl vinyl ketone, N-vinyloxazolidone, N-vinylpyrrolidone, methylenemalonnitrile, diphenyl-2-acryloyloxyethyl phosphate, dipheyl-2-methacryloyloxyethyl phosphate, dibutyl-2-acryloyloxyethyl phosphate, dioctyl-2-methacryloyloxyethyl phosphate and the like.

As the monomer having an ionic group, examples include monomers having an anionic group, and monomers having a cationic group are listed. As the monomer having an anionic group, there are listed, for example, carboxylic acid monomers, sulfonic acid monomers, phosphoric acid monomers and the like.

As the carboxylic acid monomer, there are listed, for example, acrylic acid, methacrylic acid, itaconic acid, maleic acid, fumaric acid, citraconic acid, crotonic acid, itaconic acid monoalkyl esters (for example, monomethyl itaconate, monoethyl itaconate, monobutyl itaconate and the like), maleic acid monoalkyl esters (for example, monomethyl maleate, monoethyl maleate, monobutyl maleate and the like), and the like.

As the sulfonic acid monomer, there are listed styrenesulfonic acid, vinylsulfonic acid, acryloyloxyalkylsulfonic acids (for example, acryloyloxymethylsulfonic acid, acryloyloxyethylsulfonic acid, acryloyloxypropylsulfonic acid and the like), methacryloyloxyalkylsulfonic acids (for example, methacryloyloxymethylsulfonic acid, methacryloyloxyethylsulfonic acid, methacryloyloxypropylsulfonic acid and the like), acrylamidealkylsulfonic acids (for example, 2-acrylamide-2-methylethanesulfonic acid, 2-acrylamide-2-methylpropanesulfonic acid, 2-acrylamide-2-methylbutanesulfonic acid and the like), methacrylamidealkylsulfonic acids (for example, 2-methacrylamide-2-methylethanesulfonic acid, 2-methacrylamide-2-methylpropanesulfonic acid, 2-methacrylamide-2-methylbutanesulfonic acid and the like), and the like.

As the above-mentioned phosphoric acid monomer, there are listed, for example, vinylsulfonic acid, methacryloyloxyethylphosphonic acid, and the like.

Of these, acrylic acid, methacrylic acid, styrenesulfonic acid, vinylsulfonic acid, acrylamidealkylsulfonic acid and methacrylamidealkylsulfonic acid are preferable, and acrylic acid, methacrylic acid, styrenesulfonic acid, 2-acrylamide-2-methylpropanesulfonic acid and 2-acrylamide-2-methylbutanesulfonic acid are more preferable.

As the above-mentioned monomer having a cationic group, there are listed, for example, monomers having a tertiary amino group, such as dialkylaminoethyl methacrylates, dialkylaminoethyl acrylates and the like.

As the polyurethane applicable to the ionic-group-containing polymer, there are listed, for example, polyurethanes synthesized by a polycondensation reaction of diol compounds with diisocyanate compounds, listed below in various combinations.

Examples of the above-mentioned diol compound include ethylene glycol, 1,2-propanediol, 1,3-propanediol, 1,2-butanediol, 1,3-butanediol, 2,3-butanediol, 2,2-dimehtyl-1,3-propanediol, 1,2-pentanediol, 1,4-pentanediol, 1,5-pentanediol, 2,4-pentanediol, 3,3-dimethyl-1,2-butanediol, 2-ethyl-2-methyl-1,3-propanediol, 1,2-hexanediol, 1,5-hexanediol, 1,6-hexanediol, 2,5-hexanediol, 2-methyl-2,4-pentanediol, 2,2-diethyl-1,3-propanediol, 2,4-dimethyl-2,4-pentanediol, 1,7-heptanediol, 2-methyl-2-propyl-1,3-propanediol, 2,5-dimethyl-2,-hexanediol, 2-ethyl-1,3-hexanediol, 1,2-octanediol, 1,8-octanediol, 2,2,4-trimethyl-1,3-pentanediol, 1,4-cyclohexanedimethanol, hydroquinone, diethylene glycol, triethylene glycol, dipropylene glycol, tripropylene glycol, polyethylene glycols (average molecular weight=200, 300, 400, 600, 1000, 1500, 4000), polypropylene glycols (average molecular weight=200, 400, 1000), polyester polyols, 4,4′-dihydroxy-diphenyl-2,2-propane, 4,4′-dihydroxyphenylsulfonic acid, and the like.

As the above-mentioned diisocyanate compound, examples include methylene diisocyanate, ethylene diisocyanate, isophorone diisocyanate, hexamethylene diisocyanate, 1,4-cyclohexane diisocyanate, 2,4-toluene diisocyanate, 2,6-toluene diisocyanate, 1,3-xylylene diisocyanate, 1,5-naphthalene diisocyanate, m-phenylene diisocyanate, p-phenylene diisocyanate, 3,3′-dimethyl-4,4′-diphenylmethane diisocyanate, 3,3′-dimethylbiphenylene diisocyanate, 4,4′-biphenylene diisocyanate, dicyclohexylmethane diisocyanate, methylenebis(4-cyclohexyl isocyanate), and the like.

The ionic group-containing polyurethane is obtained, for example, by using a diol having an ionic group in synthesizing the polyurethane. In this case, an ionic group is introduced, as a substituent of a polymer main chain, into the polyurethane. Examples of the diol having an ionic group, particularly an anionic group, include, but are not limited to, 2,2-bis(hydroxymethyl)propionic acid, 2,2-bis(hydroxymethyl)butanoic acid, 2,5,6-trimethoxy-3,4-dihydroxyhexanoic acid, 2,3-dihydroxy-4,5-dimethoxypentanoic acid, 3,5-di(2-hydroxy)ethyloxycarbonylbenzenesulfonic acid, and salts thereof.

As the ionic group contained in the ionic group-containing polyurethane, there are listed anionic groups such as a carboxyl group, sulfonic group, sulfuric acid monoester group, —OPO(OH)₂, sulfinate group, or salts thereof (for example, alkali metal salts of Na, K and the like, ammonium salts of ammonia, dimethylamine, ethanolamine, diethanolamine, triethanolamine, trimethylamine and the like), or cationic groups such as primary, secondary and tertiary amines and quaternary ammonium salts, and, of these, anionic groups are preferable, and a carboxyl group is particularly preferable.

The diol compounds and diisocyanate compounds usable for synthesizing the polyurethane may be used each alone, or may be used in any combination of two or more depending on various objects (for example, control of glass transition temperature (Tg), solubility, compatibility with a dye, and stability of a dispersion).

As the polyester applicable to the ionic-group-containing polymer, there are listed, for example, polyesters synthesized by a polycondensation reaction of diol compounds with diisocyanate compounds, listed below in various combinations.

As the above-mentioned dicarboxylic acid compound, there are listed oxalic acid, malonic acid, succinic acid, glutaric acid, dimethylmaleic acid, adipic acid, pimelic acid, α, α-dimethylsuccinic acid, acetonedicarboxylic acid, sebacic acid, 1,9-nonanedicarboxylic acid, fumaric acid, maleic acid, itaconic acid, citraconic acid, phthalic acid, isophthalic acid, terephthalic acid, 2-butylterephthalic acid, tetrachloroterephthalic acid, acetylenedicarboxylic acid, poly(ethyleneterephthalate)dicarboxylic acid, 1,2-cyclohexanedicarboxylic acid, 1,4-cyclohexanedicarboxylic acid, ω-poly(ethyleneoxide)dicarboxylic acid, p-xylylenedicarboxylic acid and the like.

The above-mentioned dicarboxylic acid compound may, when being polycondensed with the diol compound, be used in the form of an alkyl ester (for example, dimethyl ester) of a dicarboxylic acid or an acid chloride of a dicarboxylic acid, or be used in the form of an acid anhydride such as maleic anhydride, succinic anhydride and phthalic anhydride.

As the diol compound, the same compounds as diols exemplified for the above-mentioned polyurethane can be used.

A typical synthesis method of a polyester is a polycondensation reaction of the above-mentioned diol compound with the above-mentioned dicarboxylic acid or derivative thereof, and production can be effected also by polycondensation of a hydroxycarboxylic acid (for example, 12-hydroxystearic acid), and polyesters produced by this method can also be used. Further, polyesters obtained by a ring-opening polymerization method of a cyclic ether with lactones (described in detail in Takeo Saegusa, Koza Jugo Hannoron 6, Kaikan Jugo (1) (Lecture Polymerization Reaction Theory 6, Ring-Opening Polymerization (I)), (Kagaku Dojin, 1971)) or other methods can also be used in the present invention.

The ionic group-containing polyester can be obtained by synthesis using a dicarboxylic acid compound having an ionic group such as an anionic group such as a sulfonic group, sulfuric acid monoester group, —OPO(OH)₂, sulfinate group, or salts thereof (for example, alkali metal salts of Na, K and the like, ammonium salts of ammonia, dimethylamine, ethanolamine, diethanolamine, triethanolamine, trimethylamine and the like), or a cationic group such as primary, secondary and tertiary amines and quaternary ammonium salts, in addition to carboxylic acid. As the ionic group contained in the ionic group-containing polyester, anionic groups are preferable, and a sulfonic group is particularly preferable.

As preferable examples of the dicarboxylic acid and diol raw materials having the above-mentioned sulfonic group, examples include sulfophthalic acids (3-sulfophthalic acid, 4-sulfophthalic acid, 4-sulfoisophthalic acid, 5-sulfoisophthalic acid, 2-sulfoterephthalic acid), sulfosuccinic acid, sulfonaphthalene dicarboxylic acids (4-sulfo-1,8-naphthalenedicarboxylic acid, 7-sulfo-1,5-naphthalenedicarboxylic acid and the like), 3,5-di(2-hydroxy)ethyloxycarbonylbenzenesulfonic acid, and salts thereof.

The above-mentioned diol compounds, dicarboxylic acids and hydroxycarboxylate compounds used in synthesis of the polyester may be used each alone, or may be used in any combination of two or more depending on various objects (for example, control of glass transition temperature (Tg), solubility, compatibility with a dye, and stability of a dispersion).

As the polyamide applicable to the ionic-group-containing polymer, there are listed, for example, polyamides synthesized by polycondensation of diamine compound with dicarboxylic acid compounds listed below in various combinations. Further, examples include polyamides synthesized by polycondensation of aminocarboxylic acid compounds, and polyamides synthesized by ring-opening polymerization of lactams.

As the above-mentioned diamine compound, examples include ethylenediamine, 1,3-propanediamine, 1,2-propanediamine, hexamethylenediamine, octamethylenediamine, o-phenylenediamine, m-phenylenediamine, p-phenylenediamine, piperazine, 2,5-dimethylpiperazadine, 4,4′-diamino diphenyl ether, 3,3′-diamino diphenyl sulfone, xylylenediamine and the like. As the aminocarboxylic acid, examples include glycine, alanine, phenylalanine, ω-aminohexanoic acid, ω-aminodecanoic acid, ω-aminoundecanoic acid, and anthranylic acid. As the monomer usable in ring-opening, there are listed ε-caprolactam, azetidinone, pyrrolidone and the like.

As the above-mentioned dicarboxylic acid compound, there can be used the same compounds as the dicarboxylic acids exemplified for the above-mentioned polyester.

The above-mentioned diamine compounds, dicarboxylic acids and aminocarboxylate compounds used in synthesis of the polyamide may be used each alone, or may be used in any combination of two or more depending on various objects (for example, control of glass transition temperature (Tg), solubility, compatibility with a dye, and stability of a dispersion).

As the polyurea applicable to the ionic-group-containing polymer, there are listed, for example, polyureas synthesized by a polyaddition reaction of a diamine compound with a diisocyanate compound, listed below in various combinations. Further, there are listed polyureas synthesized by a de-ammonia reaction of diamine compounds and urea.

As the above-mentioned diamine compound, there can be used the same compounds as the diamines exemplified for the above-mentioned polyamide.

As the above-mentioned diisocyanate compound, there can be used the same compounds as the diisocyanates exemplified for the above-mentioned polyurethane.

The above-mentioned diamine compounds, diisocyanate compounds and the like used in synthesis of the polyurea may be used each alone, or may be used in any combination of two or more depending on various objects (for example, control of glass transition temperature (Tg), solubility, compatibility with a dye, and stability of a dispersion).

As the polycarbonate applicable to the ionic-group-containing polymer, there are listed, for example, polycarbonates synthesized by reacting diol compounds listed below with phosgenes or carbonate derivatives (for example, aromatic esters such as diphenylcarbonate and the like).

As the above-mentioned diol compound, there can be used the same compounds as the diols exemplified for the above-mentioned polyurethane.

The raw materials such as the diol compound and the like used in synthesis of the polycarbonate may be used each alone, or may be used in any combination of two or more depending on various objects (for example, control of glass transition temperature (Tg), solubility, compatibility with a dye, and stability of a dispersion).

The above-mentioned ionic group can be introduced into the above-mentioned each polymer by various methods. For example, when a polyurethane is used as the above-mentioned ionic-group-containing polymer, a diol containing an ionic group can be introduced as a substituent from a polymer main chain, in synthesis of the polyurethane. Further, when a polyester is used as the above-mentioned ionic-group-containing polymer, it can also be introduced by allowing it to remain as an unreacted end of a dicarboxylic acid on the end of the polyester. Further, the ionic group can also be introduced by reacting an acid anhydride (for example, maleic anhydride or the like) with a reactive group remaining on the end of the polymer, such as an —OH group, amino group or the like, after production of the above-mentioned each polymer by polymerization.

The content of the ionic group in the ionic-group-containing polymer is preferably from 0.1 to 3 mmol/g, and more preferably from 0.2 to 2 mmol/g. When the content of the ionic group is too low, contribution of the polymer to dispersion stability decreases, and when too high, water-solubility increases, leading to unsuitability for dispersion of the dye.

Of the ionic-group-containing polymers, vinyl polymers, polyurethanes and polyesters are preferable, and vinyl polymers are particularly preferable from the standpoints of compatibility of the polymer with the oil-soluble dye, ease of introducing an ionic group which can improve dispersion stability of the polymer, and the like. Vinyl polymers having at least one of a carboxyl group and sulfonic group as the ionic group are most preferable.

Exemplified compounds (P-1) to (P-84) of the above-mentioned ionic group-containing vinyl polymer will be listed below. Ratios in parentheses means ratio by mass. The present invention is in no way limited to these compounds.

P-1) tert-butylmethacrylamide-methyl methacrylate-acrylic acid copolymer (60:30:10)

P-2) n-butylacrylate-acrylic acid copolymer (80:20)

P-3) methyl methacrylate-isobutyl methacrylate-acrylic acid copolymer (52:28:20)

P-4) sec-butyl acrylate-acrylic acid copolymer (85:15)

P-5) n-butyl methacrylate-pentyl methacrylate-methacrylic acid copolymer (38:38:24)

P-6) ethyl acrylate-acrylic acid copolymer (95:5)

P-7) isopropyl acrylate-acrylic acid copolymer (90:10)

P-8) butyl methacrylate-2-hydroxyethyl methacrylate-acrylic acid copolymer (85:5:10)

P-9) cyanoethyl acrylate-benzyl methacrylate-acrylic acid copolymer (60:30:10)

P-10) isobutyl methacrylate-tetrahydrofurfuryl acrylate-acrylic acid copolymer (60:30:10)

P-11) n-butyl methacrylate-methacrylic acid copolymer (90:10)

P-12) n-butyl methacrylate-1H,1H,2H,2H-perfluorodecyl acrylate-acrylic acid copolymer (75:20:5)

P-13) methyl methacrylate-n-butyl acrylate-acrylic acid copolymer (50:45:5)

P-14) 2-ethylhexyl methacrylate-methyl acrylate-acrylic acid copolymer (40:55:5)

P-15) 3-methoxybutyl methacrylate-styrene-acrylic acid copolymer (35:50:15)

P-16) cyclohexyl methacrylate-allyl methacrylate-acrylic acid copolymer (35:50:15)

P-17) isopropyl methacrylate-furfuryl methacrylate-acrylic acid copolymer (80:10:10)

P-18) isopropyl methacrylate-2-butoxyethyl methacrylate-acrylic acid copolymer (75:15:10)

P-19) ethyl acrylate-phenyl methacrylate-acrylic acid copolymer (72:15:13)

P-20) isobutyl methacrylate-2-(2-ethoxyethoxy)ethyl methacrylate-acrylic acid copolymer (80:10:10)

P-21) isobutyl methacrylate-methacrylate of polyethylene glycol monomethyl ether (repetition number of ethyleneoxy chain is 23)-acrylic acid copolymer (70:20:10)

P-22) isobutyl methacrylate-dipropylene glycol monomethacrylate-acrylic acid copolymer (85:5:10)

P-23) isobutyl methacrylate-methacrylate of polyethylene glycol monomethyl ether (repetition number of ethyleneoxy chain is 9)-acrylic acid copolymer (80:10:10)

P-24) isobutyl acrylate-glycidyl methacrylate-acrylic acid copolymer (75:15:10)

P-25) isobutyl acrylate-methoxystyrene-acrylic acid copolymer (75:15:10)

P-26) isobutyl acrylate-N-vinylpyrrolidone-acrylic acid copolymer (60:30:10)

P-27) tert-butyl acrylate-methacrylic acid copolymer (88:12)

P-28) hexyl acrylate-styrene-methacrylic acid copolymer (80:5:15)

P-29) 2,2,2-tetrafluoroethyl methacrylate-methyl methacrylate-methacrylic acid copolymer (25:60:15)

P-30) ethyl methacrylate-2-methoxyethyl methacrylate-methacrylic acid copolymer (70:15:15)

P-31) ethyl methacrylate-2-ethoxyethyl methacrylate-methacrylic acid copolymer (70:15:15)

P-32) vinyl acetate-methacrylic acid copolymer (85:15)

P-33) n-butyl methacrylate-acrylamide-methacrylic acid copolymer (70:15:15)

P-34) tert-octylacrylamide-propyl methacrylate-methacrylic acid copolymer (20:65:15)

P-35) n-butyl methacrylate-butoxymethylacrylamide-methacrylic acid copolymer (80:5:15)

P-36) n-butyl methacrylate-diphenyl-2-methacryloyloxyethylphosphate-methacrylic acid copolymer (50:35:15)

P-37) isobutyl methacrylate-dimethylacrylamide-methacrylic acid copolymer (70:15:15)

P-38) n-butyl methacrylate-butylacrylamide-methacrylic acid copolymer (70:15:15)

P-39) n-butyl methacrylate-phenylacrylamide-methacrylic acid copolymer (70:15:15)

P-40) n-butyl methacrylate-methacrylamide-methacrylic acid copolymer (70:15:15)

P-41) n-butyl methacrylate-methoxyethylmethacrylamide-methacrylic acid copolymer (70:15:15)

P-42) n-butyl methacrylate-N-vinylpyrrolidone-methacrylic acid copolymer (70:15:15)

P-43) isobutyl methacrylate-1H,1H,2H,2H-perfluorodecyl acrylate-methacrylic acid copolymer (55:30:15)

P-44) isobutyl methacrylate-2-(2-methoxyethoxy)ethyl methacrylate-methacrylic acid copolymer (50:35:15)

P-45) n-butyl methacrylate-styrenesulfonic acid copolymer (90:10)

P-46) ethyl methacrylate-styrenesulfonic acid copolymer (90:10)

P-47) n-butyl acrylate-styrene-styrenesulfonic acid copolymer (80:10:10)

P-48) isobutyl methacrylate-styrenesulfonic acid copolymer (90:10)

P-49) isobutyl acrylate-triethylene glycol monomethacrylate-styrenesulfonic acid copolymer (80:10:10)

P-50) n-butyl acrylate-1H,1H,2H,2H-perfluorodecyl methacrylate-styrenesulfonic acid copolymer (80:10:10)

P-51) n-butyl acrylate-2-butoxyethyl methacrylate-styrenesulfonic acid copolymer (70:20:10)

P-52) n-butyl methacrylate-2-acrylamide-2-methylethanesulfonic acid copolymer (90:10)

P-53) n-butyl acrylate-2-butoxyethyl methacrylate-2-acrylamide-2-methylethanesulfonic acid copolymer (70:20:10)

P-54) isobutyl methacrylate-2-acrylamide-2-methylethanesulfonic acid copolymer (90:10)

P-55) isobutyl acrylate-n-butyl methacrylate-2-acrylamide-2-methylethanesulfonic acid copolymer (70:20:10)

P-56) ethyl acrylate-tert-butyl methacrylate-2-acrylamide-2-methylethanesulfonic acid copolymer (60:30:10)

P-57) n-butyl methacrylate-2-acrylamide-2-methylpropanesulfonic acid copolymer (90:10)

P-58) ethyl methacrylate-2-acrylamide-2-methylpropanesulfonic acid copolymer (90:10)

P-59) ethyl acrylate-tert-butyl methacrylate-2-acrylamide-2-methylpropanesulfonic acid copolymer (60:30:10)

P-60) n-butyl acrylate-tert-butyl methacrylate-2-acrylamide-2-methylpropanesulfonic acid copolymer (60:30:10)

P-61) tert-butyl acrylate-tetrahydrofurfurylacrylate-2-acrylamide-2-methylpropanesulfonic acid copolymer (50:40:10)

P-62) tert-butyl acrylate-1H,1H,2H, 2H-perfluorodecyl methacrylate-2-acrylamide-2-methylpropanesulfonic acid copolymer (60:30:10)

P-63) tert-butyl acrylate-methacrylate of polyethylene glycol monomethyl ether (repetition number of ethyleneoxy chain is 23)-2-acrylamide-2-methylpropanesulfonic acid (70:27:3)

P-64) isobutyl acrylate-N-vinylpyrrolidone-2-acrylamide-2-methylpropanesulfonic acid (60:30:10)

P-65) ethyl methacrylate-sodium 2-acrylamide-2-methylpropanesulfonate copolymer (90.4:9.6)

P-66) n-butyl methacrylate-sodium 2-acrylamide-2-methylpropanesulfonate copolymer (98:2)

P-67) isobutyl methacrylate-sodium 2-acrylamide-2-methylpropanesulfonate copolymer (90.4:9.6)

P-68) n-butyl methacrylate-tert-butyl methacrylate-sodium 2-acrylamide-2-methylpropanesulfonate copolymer (50:35:15)

P-69) vinylpyrrolidone-isobutyl methacrylate-sodium 2-acrylamide-2-methylpropanesulfonate copolymer (50:35:15)

P-70) n-butyl methacrylate-2-methacrylamide-2-methylpropanesulfonic acid copolymer (90:10)

P-71) n-butyl acrylate-tert-butyl methacrylate-2-methacrylamide-2-methylpropanesulfonic acid copolymer (60:30:10)

P-72) isobutyl acrylate-hydroxymethylacrylamide-2-methacrylamide-2-methylpropanesulfonic acid copolymer (80:10:10)

P-73) n-butyl acrylate-tert-butyl methacrylate-vinylsulfonic acid copolymer (60:30:10)

P-74) hexyl methacrylate-methyl methacrylate-vinylsulfonic acid copolymer (40:45:15)

P-75) ethyl acrylate-tert-butyl methacrylate-vinylsulfonic acid copolymer (60:30:10)

P-76) n-butyl methacrylate-2-acrylamide-2-methylbutanesulfonic acid copolymer (90:10)

P-77) ethyl methacrylate-2-acrylamide-2-methylbutanesulfonic acid copolymer (90:10)

P-78) ethyl acrylate-tert-butyl methacrylate-2-acrylamide-2-methylbutanesulfonic acid copolymer (60:30:10)

P-79) n-butyl acrylate-tert-butyl methacrylate-2-acrylamide-2-methylbutanesulfonic acid copolymer (60:30:10)

P-80) ethyl methacrylate-sodium 2-acrylamide-2-methylbutanesulfonate copolymer (90.4:9.6)

P-81) n-butyl methacrylate-sodium 2-acrylamide-2-methylbutanesulfonate copolymer (98:2)

P-82) isobutyl methacrylate-sodium 2-acrylamide-2-methylbutanesulfonate copolymer (90.4:9.6)

P-83) n-butyl methacrylate-tert-butyl methacrylate-sodium 2-acrylamide-2-methylbutanesulfonate copolymer (50:35:15)

P-84) n-butyl methacrylate-2-methacrylamide-2-methylbutanesulfonic acid copolymer (90:10)

Of the ionic-group-containing polymers, exemplified compounds (P-85) to (P-104) of the condensed type polymer will be listed below. Ratios in parentheses mean ratio by mass. The present invention is in no way limited to these compounds.

P-85) 4,4′-diphenylmethane diisocyanate/hexamethylene diisocyanate/tetraethylene glycol/ethylene glycol/2,2-bis(hydroxymethyl)propionic acid (40/10/20/20/10)

P-86) 4,4′-diphenylmethane diisocyanate/hexamethylene diisocyanate/butanediol/polyethylene glycol (Mw=400)/2,2-bis(hydroxymethyl)propionic acid (40/10/20/10/20)

P-87) 1,5-naphthylene diisocyanate/butanediol/4,4′-dihydroxy-diphenyl-2,2-propane/polypropylene glycol

(Mw=400)/2,2-bis(hydroxymethyl)propionic acid (50/20/5/10/15)

P-88) 1,5-naphthylene diisocyanate/hexamethylene diosocyanate/2,2-bis (hydroxymethyl)butanoic acid/polybutylene oxide (Mw=500) (35/15/25/25)

P-89) isophorone diisocyanate/diethylene glycol/neopentyl glycol/2,2-bis(hydroxymethyl)propionic acid (50/20/20/10)

P-90) toluene diisocyanate/2,2-bis(hydroxymethyl)butanoic acid/polyethylene glycol (Mw=1000)/cyclohexanonedimethanol (50/10/10/30)

P-91) diphenylmethane diisocyanate/hexamethylene diisocyanate/tetraethylene glycol/butanediol/3,5-di(2-hydroxy)ethyloxycarbonylbenzenesulfonic acid (40/10/10/33/7)

P-92) diphenylmethane diisocyanate/hexamethylene diisocyanate/butanediol/ethylene glycol/2,2-bis(hydroxymethyl)butanoic acid/3,5-di(2-hydroxy)ethyloxycarbonylbenzenesulfonic acid (40/10/20/15/10/5)

P-93) terephthalic acid/isophthalic acid/5-sulfoisophthalic acid/ethylene glycol/neopentyl glycol (24/24/2/25/25)

P-94) terephthalic acid/isophthalic acid/5-sulfoisophthalic acid/cyclohexanedimethanol/1,4-butanediol/ethylene glycol (22/22/6/25/15/10)

P-95) isophthalic acid/5-sulfoisophthalic acid/cyclohexanedimethanol/ethylene glycol (40/10/40/10)

P-96) cyclohexanedicarboxylic acid/isophthalic acid/3,5-di(2-hydroxy)ethyloxycarbonylbenzenesulfonic acid/cyclohexanedimethanol/ethylene glycol (30/20/5/25/20)

P-97) 11-aminoundecanoic acid (100)

P-98) 12-aminododecanoic acid (100)

P-99) reaction product of poly(12-aminododecanoic acid) and maleic anhydride

P-100) 11-aminoundecanoic acid/7-aminoheptanoic acid (50/50)

P-101) hexamethylenediamine/adipic acid (50/50)

P-102) N,N′-dimethylethylenediamine/adipic acid/cyclohexanedicarboxylic acid (50/20/30)

P-103) toluene diisocyanate/hexamethylenediamine/2,2-bis(hydroxymethyl)propionic acid (50/40/10)

P-104) 11-aminoundecanoic acid/hexamethylenediamine/urea (33/33/33)

Regarding synthesis of the ionic-group-containing polymer, there are used methods described in “Kobunshi Jikkengaku (Polymer Experiment Study) Vol. 5 Jushukugo to Juhuka “(Polycondensation and Polyaddition)(Shu Kanbara ed., issued by Kyoritsu Shuppan K. K. (1980), “Poriesuteru Jushi Handobukku” (Polyester Resin Handbook) (Eiichiro Takiyama ed., issued by Nikkan Kogyo Shinbunsha (988), “Poriuretan Jushi Handobukku” (Polyurethane Resin Handbook) (Keiji Iwata ed., issued by Nikkan Kogyo Shinbunsha (987), “Koubnshi Gosei no Jikkenho” (Experiment Method of Polymer Synthesis) (Takayuki Otsu and Masaetsu Kinoshita co.ed., issued by Kagaku Dojin (1972), JP-B Nos. 33-1141, 37-7641, 39-5989, 40-27349, 42-5118, 42-24194, 45-10957, 48-25435, 49-36942, 52-81344, JP-A Nos. 56-88454, 6-340835 and the like.

The molecular weight (Mw) of the ionic-group-containing polymer is usually from 1000 to 200000, preferably from 2000 to 50000. If the above-mentioned molecular weight is less than 1000, obtaining a stable dispersion of the coloring particulate tends to become difficult, and if over 200000, solubility into the organic solvent tends to deteriorate, or the viscosity of the organic solvent tends to increase, causing poor dispersibility.

—Hydrophobic higher boiling point organic solvent—

In the present invention, the coloring particulate contains a hydrophobic high-boiling-point organic solvent. This hydrophobic high-boiling-point organic solvent is hydrophobic and has a boiling point of 150° C. or more. Here, the term “hydrophobic” means that solubility in distilled water at 25° C. is 3% or less. It is preferable that the boiling point of the hydrophobic high-boiling-point organic solvent is 170° C. or more. The dielectric constant of the hydrophobic high-boiling-point organic solvent is preferably from 3 to 12, and more preferably from 4 to 10. The “dielectric constant” herein referred to indicates relative dielectric constant relative to a vacuum at 25° C.

As the hydrophobic high-boiling-point organic solvent, compounds described in U.S. Pat. No. 2,322,027 can be used, and preferable examples thereof include, but are not limited to, hydrophobic high-boiling-point organic solvents derived from phosphates, fatty esters, phthalates, benzoates, phenols and amides.

As the hydrophobic high-boiling-point organic solvent used in the present invention, compounds represented by the following formulae [S-1] to [S-9] are particularly preferable.

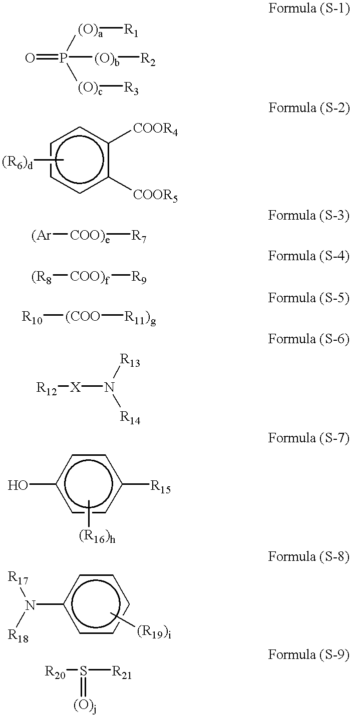

In the formula [S-1], R₁, R₂ and R₃ each independently represents an aliphatic group or aryl group. a, b, c each independently represents 0 or 1.

In the formula [S-2], R₄ and R₅ each independently represents an aliphatic group or aryl group, R₆ represents a halogen atom (the halogen atom is F, Cl, Br, I which is the same as in the following the high-boiling-point organic solvents), alkyl group, alkoxy group, aryloxy group, alkoxycarbonyl group or aryloxycarbonyl group, and d represents an integer from 0 to 3. When d is two or more, a plurality of R₆s may be the same or different.

In the formula [S-3], Ar represents an aryl group, e represents an integer from 1 to 6, and R₇ represents an e-valent hydrocarbon group or a hydrocarbon group mutually bonded via ether bond.

In the formula [S-4], R₈ represents an aliphatic group, f represents an integer from 1 to 6, and R₉ reprsents an f-valent hydrocarbon group or a hydrocarbon group mutually bonded via ether bond.

In the formula [S-5], g represents and integer from 2 to 6, and R₁₀ represents a g-valent hydrocarbon group (excepting an aryl group), and R₁₁ represents an aliphatic group or an aryl group.

In the formula [S-6], R₁₂, R₁₃ and R₁₄ each independently represents a hydrogen atom, aliphatic group or aryl group. X represents —CO— or —SO₂—. R₁₂ and R₁₃ or R₁₃ and R₁₄ may bond mutually to form a ring.

In the formula [S-7], R₁₅ represents an aliphatic group, alkoxycarbonyl group, aryloxycarbonyl group, alkylsulfonyl group, arylsulfonyl group, aryl group or cyano group, R₁₆ represents a halogen atom, aliphatic group, aryl group, alkoxy group or aryloxy group, and h represents an integer of 0 to 3. When h is 2 or more, a plurality of R₁₆s may be the same or different.

In the formula [S-8], R₁₇ and R₁₈ each independently represents an aliphatic group or aryl group, R₁₉ represents a halogen atom, aliphatic group, aryl group, alkoxy group or aryloxy group, i represents an integer from 0 to 4. When i is 2 or more, a plurality of R₁₉s may be the same or different.

In the formula [S-9], R₂₀ and R₂₁ represent an aliphatic group or aryl group. j represents 1 or 2.

In the formulae [S-1] to [S-9], when any of R₁ to R₆, R₈, and R₁₁ to R₂₁ is an aliphatic group or a group containing an aliphatic group, the aliphatic group may be any of linear, branched and cyclic, and may contain an unsaturated bond or have a substituent. Examples of the substituent include halogen atoms, aryl groups, alkoxy groups, aryloxy groups, alkoxycarbonyl groups, hydroxyl groups, acyloxy groups, epoxy groups and the like.

In the formulae [S-1] to [S-9], when any of R₁ to R₆, R₈, and R₁₁ to R₂₁ is a cyclic aliphatic group, namely, a cycloalkyl group or a group containing a cycloalkyl group, the cycloalkyl group may contain an unsaturated bond in a 3 to 8-member ring, or may have a substituent or crosslinked group. Examples of the substituent include halogen atoms, aliphatic groups, hydroxyl groups, acyl groups, aryl groups, alkoxy groups, epoxy groups, alkyl groups and the like, and examples of the crosslinked group include methylene, ethylene, isopropylidene and the like.

In the formulae [S-1] to [S-9], when any of R₁ to R₆, R₈, and R₁₁ to R₂₁ is an aryl group or a group containing an aryl group, the aryl group may be substituted with a substituent such as a halogen atom, aliphatic group, aryl group, alkoxy group, aryloxy group, alkoxycarbonyl group and the like.

In the formulae [S-3], [S-4] and [S-5], when any of R₇, R₉ or R₁₀ represents a hydrocarbon group, the hydrocarbon group may contain a cyclic structure (for example, a benzene ring, cyclopentane ring, cyclohexane ring) or an unsaturated bond, or may have a substituent. Examples of the substituent include halogen atoms, hydroxyl group, acyloxy group, aryl groups, alkoxy groups, aryloxy groups, epoxy groups and the like.

Of the hydrophobic high-boiling-point organic solvents represented by the formulae [S-1] to [S-9], particularly preferable hydrophobic high-boiling-point organic solvents will be illustrated.

In the formula [S-1], R₂ and R₃ each independently represents an aliphatic group in which a number of carbon atoms (hereinafter, abbreviated as C number) is from 1 to 24 (preferably, from 4 to 18) (for example, n-butyl, 2-ethylhexyl, 3,3,5-trimethylhexyl, n-dodecyl, n-octadecyl, benzyl, oleyl, 2-chloroethyl, 2,3-dichloropropyl, 2-butoxyethyl, 2-phenoxyethyl, cyclopentyl, cyclohexyl, 4-t-butylcyclohexyl, 4-methylcyclohexyl), or an aryl group having a C number of 6 to 24 (preferably, 6 to 18) (for example, phenyl, cresyl, p-nonylphenyl, xylyl, cumenyl, p-methoxyphenyl, p-methoxycarbonylphenyl). a, b and c each independently represents 0 or 1 and, more preferably, a, b and c are all 1.

In the formula [S-2], R₄ and R₅ each represents an aliphatic group having a C number of 1 to 24 (preferably, 4 to 18) (for example, the same alkyl group as listed for the above-mentioned R₁, ethoxycarbonylmethyl, 1,1-diethylpropyl, 2-ethyl-1-methylhexyl, cyclohexylmethyl, 1-ethyl-1,5-dimethylhexyl, 3,5,5-trimethylcyclohexyl, mentyl, bornyl, 1-methylcyclohexyl), or an aryl group having a C number of 6 to 24 (preferably, 6 to 18) (for example, the same aryl group as listed for R₁, 4-t-butylphenyl, 4-t-octylphenyl, 1,3,5-trimethylphenyl, 2,4-di-t-butylphenyl, 2,4-di-t-pentylphenyl), and R₆ represents a halogen atom (preferably a chlorine atom), an alkyl group having a C number of 1 to 18 (for example, methyl, isopropyl, t-butyl, n-dodecyl), an alkoxy group having a C number of 1 to 18 (for example, methoxy, n-butoxy, n-octyloxy, methoxyethoxy, benzyloxy), an aryloxy group having a C number of 6 to 18 (for example, phenoxy, p-tolyloxy, 4-methoxyphenoxy, 4-t-butylphenoxy), an alkoxycarbonyl group having a C number of 2 to 19 (for example, methoxycarbonyl, n-butoxycarbonyl, 2-ethylhexyloxycarbonyl) or an aryloxycarbonyl group having a C number of 6 to 25, and d is 0 or 1.

In the formula [S-3], Ar represents an aryl group having a C number of 6 to 24 (preferably, 6 to 18) (for example, phenyl, 4-chlorophenyl, 4-methoxyphenyl, 1-naphthyl, 4-n-butoxyphenyl, 1,3,5-trimethylphenyl), e is an integer from 1 to 4 (preferably, from 1 to 3), and R₇ is an e-valent hydrocarbon group having a C number of 2 to 24 (preferably, 2 to 18) [for example, the above-mentioned alkyl groups as listed for R₄, a cycloalkyl groups, aryl group, —(CH₂)—,

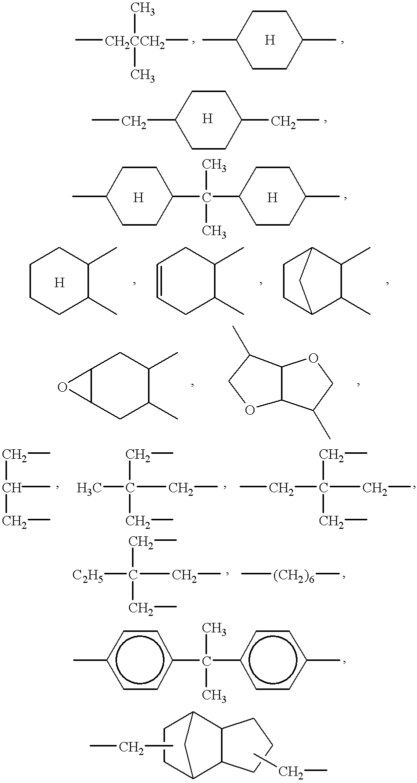

], or an e-valent hydrocarbon group mutually bonded via ether bond and having a C number of 2 to 24 (preferably, 4 to 18) [for example, —CH₂CH₂OCH₂CH₂—, —CH₂CH₂(OCH₂CH₂)₃—, —CH₂CH₂CH₂OCH₂CH₂CH₂—,

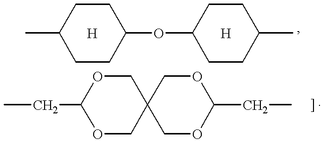

In the formula [S-4], R₈ represents an aliphatic group having a C number of 3 to 24 (preferably, 3 to 17) (for example, n-propyl, 1-hydroxyethyl, 1-ethylpentyl, n-undecyl, pentadecyl, 8,9-epoxyheptadecyl, cyclopropyl, cyclohexyl, 4-methylcyclohexyl), f is an integer from 1 to 4 (preferably, 1 to 3), and R₉ is an f-valent hydrocarbon group having a C number of 2 to 24 (preferably, 2 to 18) or a f-valent hydrocarbon group mutually bonded via ether bond and having a C number of 4 to 24 (preferably, 4 to 18) (for example, the above-mentioned groups listed for R₇).

In the formula [S-5], g is 2 to 4 (preferably, 2 or 3), and R₁₀ represents a g-valent hydrocarbon group [for example, —CH₂—, —(CH₂)₂—, —(CH₂)₄—, —(CH₂)₇—,

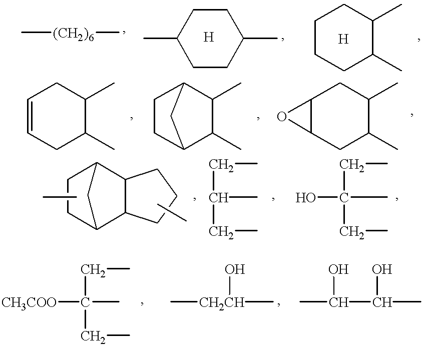

], and R₁₁ represents an aliphatic group having a C number of 1 to 24 (preferably, 4 to 18) or an aryl group having a C number of 6 to 24 (preferably, 6 to 18) (for example, the above-mentioned aliphatic groups, and aryl groups listed for R₄).

In the formula [S-6], R₁₂ represents an aliphatic group having a C number of 1 to 20 [for example, n-propyl, 1-ethylpentyl, n-undecyl, n-pentadecyl, 2,4-di-t-pentylphenoxymethyl, 4-t-octylphenoxymethyl, 3-(2,4-di-t-butylphenoxy)propyl, 1-(2,4-di-t-butylphenoxy)propyl, cyclohexyl, 4-methylcyclohexyl) or an aryl group having a C number of 6 to 24 (preferably, 6 to 18) (for example, the above-mentioned aryl groups listed for Ar), and R₁₃ and R₁₄ each represents an aliphatic group having a C number of 3 to 24 (preferably, 3 to 18) (for example, isopropyl, n-butyl, n-hexyl, 2-ethylhexyl, n-dodecyl, cyclopentyl, cyclopropyl) or an aryl group having a C number of 6 to 18 (preferably, 6 to 15) (for example, phenyl group, 1-naphthyl group, p-tolyl). R₁₃ and R₁₄ may be bonded each other to form with N a pyrrolidine ring, piperidine ring or morpholine ring, or R₁₂ and R₁₃ may be bonded with each other to form a pyrrolidone ring. X represents —CO— or —SO₂—, and X preferably represents —CO—.

In the formula [S-7], R₁₅ represents an aliphatic group having a C number of 1 to 24 (preferably, 3 to 18) (for example, methyl, isopropyl, t-butyl, t-pentyl, t-hexyl, t-octyl, 2-butyl, 2-hexyl, 2-octyl, 2-dodecyl, 2-hexadecyl, t-pentadecyl, cyclopentyl, cyclohexyl), an alkoxycarbonyl group having a C number of 2 to 24 (preferably, 5 to 17) (for example, n-butoxycarbonyl, 2-ethylhexyloxycarbonyl, n-dodecyloxycarbonyl), an alkylsulfonyl group having a C number of 1 to 24 (preferably, 3 to 18) (for example, n-butylsulfonyl, n-dodecylsulfonyl), an arlsulfonyl group having a C number of 6 to 30 (preferably, 6 to 24) (for example, p-tolylsulfonyl, p-dodecylphenylsulfonyl, p-hexadecyloxyphenylsulfonyl), an aryl group having a C number of 6 to 32 (preferably, 6 to 24) (for example, phenyl, p-tolyl), or a cyano group, R₁₆ represents a halogen atom (preferably, Cl), an alkyl group having a C number of 1 to 24 (preferably, 3 to 18) (for example, the above-mentioned alkyl groups listed for R₁₅), a cycloalkyl group having a C number of 5 to 17 (for example, cyclopentyl, or cyclohexyl), an aryl group having a C number of 6 to 32 (preferably, 6 to 24) (for example, phenyl, p-tolyl), an alkoxy group having a C number of 1 to 24 (preferably, 1 to 18) (for example, methoxy, n-butoxy, 2-ethylhexyloxy, benzyloxy, n-dodecyloxy, n-hexadecyloxy) or an aryloxy group having a C number of 6 to 32 (preferably, 6 to 24) (for example, phenoxy, p-t-butylphenoxy, p-t-octylphenoxy, m-pentadecylphenoxy, p-dodecyloxyphenoxy), and h is an integer of 1 to 2.

In the formula [S-8], R₁₇ and R₁₈ are the same as the above-mentioned R₁₃ and R₁₄, and R₁₉ is the same as the above-mentioned R₁₆.

In the formula [S-9], R₂₀ and R₂₁ are the same as the above-mentioned R₁, R₂ and R₃. j represents 1 or 2, and j preferably represents 1.

Specific examples S-1 to S-81 of the hydrophobic high-boiling-point organic solvent used in the present invention will be shown below.

Compound represented by the formula [S-1]

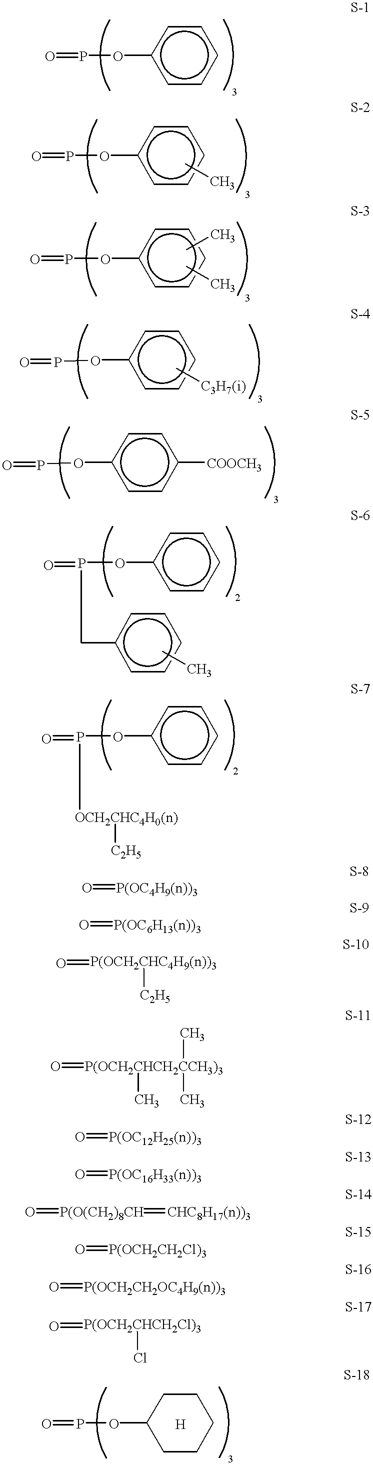

Compound represented by the formula [S-2]

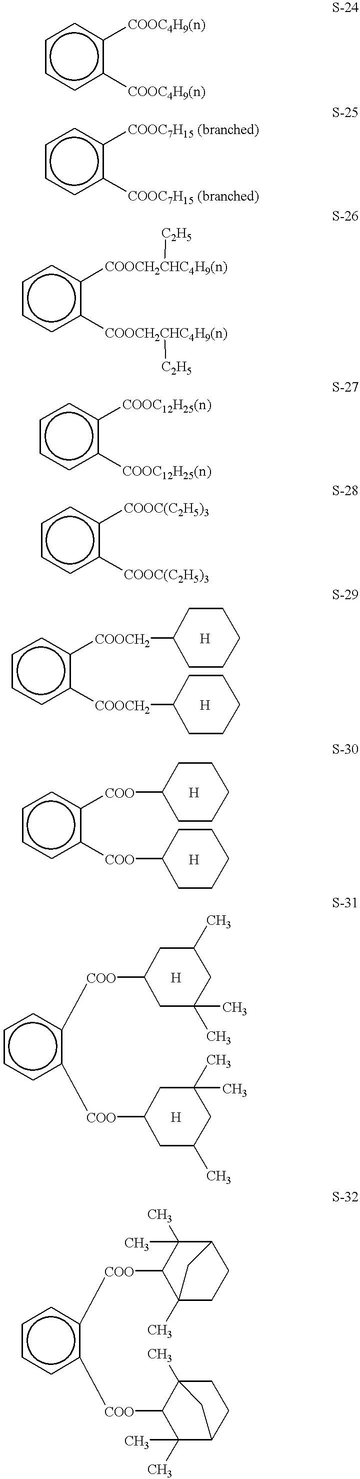

Compound represented by the formula [S-3]

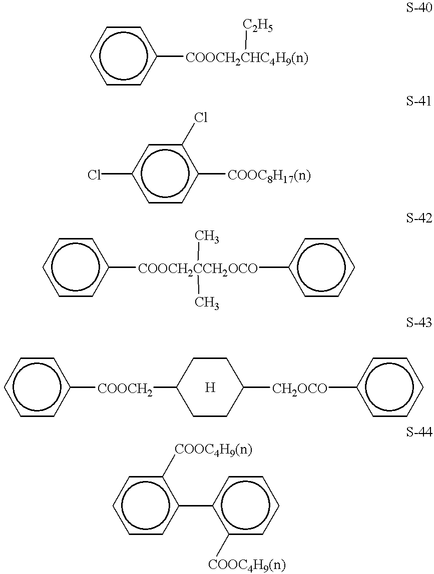

Compound represented by the formula [S-4]

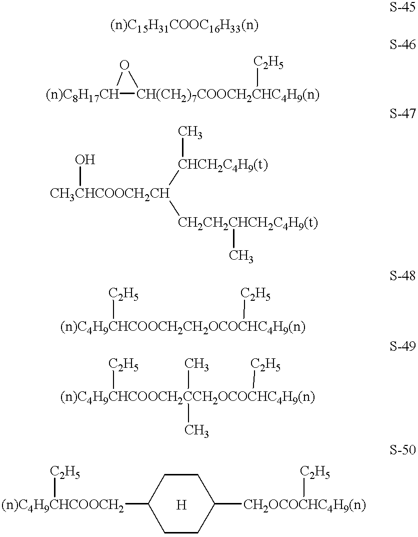

Compound represented by the formula [S-5]

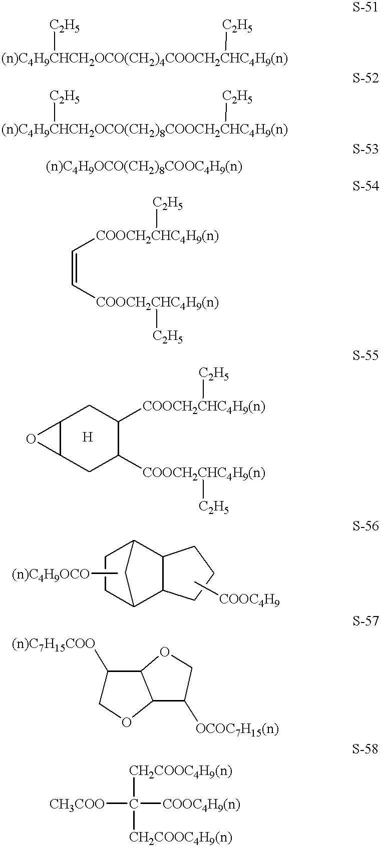

Compound represented by the formula [S-6]

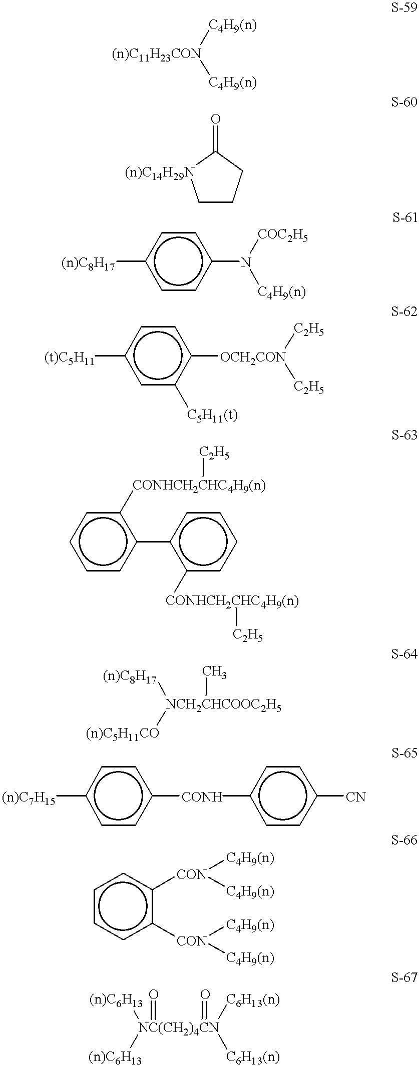

Compound represented by the formula [S-7]

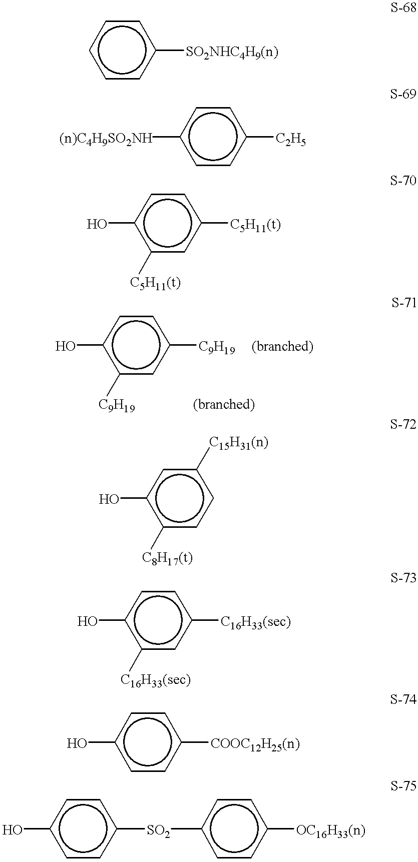

Compound represented by the formula [S-8]

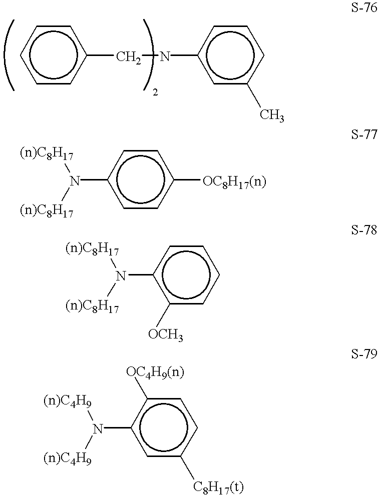

Compound represented by the formula [S-9]

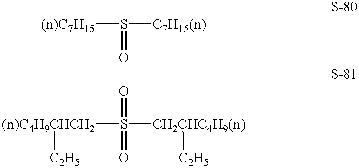

In the present invention, the hydrophobic high-boiling-point organic solvent may be used alone, or in a mixture of two or more [for example tricresyl phosphate and dibutyl phthalate, trioctyl phosphate and di(2-ethylhexyl) sebacate].

Examples other than the above-mentioned compounds of the hydrophobic high-boiling-point organic solvent used in the present invention and/or synthesis methods of these hydrophobic high-boiling-point organic solvents are described in, for example, U.S. Pat. Nos. 2,322,027, 2,533,514, 2,772,163, 2,835,579, 3,594,171, 3,676,137, 3,689,271, 3,700,454, 3,746,141, 3,764,336, 3,765,897, 3,912,515, 3,936,303, 4,004,928, 4,080,209, 4,127,413, 4,193,802, 4,207,393, 4,220,711, 4,239,851, 4,278,757, 4,353,979, 4,363,873, 4,430,421, 4,430,422, 4,464,464, 4,483,918, 4,540,657, 4,684,606, 4,728,599, 4,745,049, 4,935,321 and 5,013,639, EU Patent Nos. 276,319A, 286,253A, 289,820A, 309,158A, 309,159A, 309,160A, 509,311A, and 510,576A, East Germany Patent Nos. 147,009, 157,147, 159,573, and 225,240A, GB Patent Nos. 2,091,124A and the like, and JP-A Nos. 48-47335, 50-26530, 51-25133, 51-26036, 51-27921, 51-27922, 51-149028, 52-46816, 53-1520, 53-1521, 53-15127, 53-146622, 54-91325, 54-106228, 54-118246, 55-59464, 56-64333, 56-81836, 59-204041, 61-84641, 62-118345, 62-247364, 63-167357, 63-214744, 63-301941, 64-9452, 64-9454, 64-68745, 1-101543, 1-102454, 2-792, 2-4239, 2-43541, 4-29237, 4-30165, 4-232946, 4-346338 and the like.

—Production of coloring composition containing ionic-group—containing polymer—

The coloring composition of the present invention is produced by dispersing, in a water-based medium, a coloring particulate containing an oil-soluble dye, the ionic-group-containing polymer and the hydrophobic high-boiling-point organic solvent. Specifically, there are listed, for example, a method in which a latex of the ionic-group-containing polymer is previously prepared, and the oil-soluble dye and the hydrophobic high-boiling-point organic solvent are impregnated thereinto, a co-emulsifying dispersion method and the like. Of these, the co-emulsifying dispersion method is preferable. As the co-emulsifying dispersion method, there is suitably used a method in which water is added to an organic solvent phase containing the ionic-group-containing polymer, the oil-soluble dye and the hydrophobic high-boiling-point organic solvent, and the organic solvent phase is added to water to emulsify the organic solvent phase to give fine particles.

The above-mentioned latex means a state in which the ionic-group-containing polymer is dispersed as fine particles in a water-based medium. As the dispersion state, any of a state in which the ionic-group-containing polymer is emulsified, emulsion-polymerized or micelle-dispersed in the above-mentioned water-based medium, a state in which the ionic-group-containing polymer partially has a hydrophilic structure in the molecule thereof and the molecular chain itself is dispersed in molecular form, or the like may be permissible.

Here, a method by which the latex is previously prepared and the oil-soluble dye and the hydrophobic high-boiling-point organic solvent are impregnated thereinto will be illustrated.

A first example of this method comprises a first step in which polymer latex is prepared, a second step in which a dye solution is prepared by dissolving the oil-soluble dye and the hydrophobic high-boiling-point organic solvent into an organic solvent, and a third step in which a coloring composition is prepared by mixing the above-mentioned dye solution and the polymer latex.

A second example of this method comprises a first step in which polymer latex is prepared, a second step in which a dye solution is prepared by dissolving the oil-soluble dye and the hydrophobic high-boiling-point organic solvent into an organic solvent, and this dye solution is mixed with a solution containing at least water to prepared a dye fine particle dispersion, and a third step in which a coloring composition is prepared by mixing the polymer latex and the dye fine particle dispersion.

As a third example of this method, there is a method described in JP-A No. 55-139471.

Next, the co-emulsifying dispersion method will be illustrated.

A first example of this method includes a first step in which a solution is prepared by dissolving the oil-soluble dye, the ionic-group-containing polymer and the hydrophobic high-boiling-point organic solvent into an organic solvent, and a second step in which a coloring composition is prepared by mixing the organic solvent solution containing the polymer, the dye and the hydrophobic high-boiling-point organic solvent with a solution containing at least water.

A second example of this method includes a first step in which a dye solution is prepared by dissolving the oil-soluble dye into an organic solvent, a second step in which a polymer solution is prepared by dissolving the ionic-group-containing polymer and the hydrophobic high-boiling-point organic solvent into an organic solvent, and a third step in which a coloring composition is prepared by mixing the above-mentioned dye solution, the above-mentioned polymer solution and a solution containing at least water. The above-mentioned hydrophobic high-boiling-point organic solvent may be used in the first step, or may be used in the first step and the second step. This condition is applied to the following third and fourth examples.

A third example of this method includes a first step in which a dye solution is prepared by dissolving the oil-soluble dye into an organic solvent, and a dye fine particle dispersion is prepared by mixing this dye solution with a solution containing at least water, a second step in which a polymer solution is prepared by dissolving the ionic-group-containing polymer and the hydrophobic high-boiling-point organic solvent into an organic solvent, and a polymer fine particle dispersion is prepared by mixing this polymer solution with a solution containing at least water, and a third step in which a coloring composition is prepared by mixing the dye fine particle dispersion with the polymer fine particle dispersion.

A fourth example of this method includes a first step in which a dye solution is prepared by dissolving the oil-soluble dye into an organic solvent, and a dye fine particle dispersion is prepared by mixing this dye solution with a solution containing at least water, a second step in which a polymer solution is prepared by dissolving the ionic-group-containing polymer and the hydrophobic high-boiling-point organic solvent into an organic solvent, and a third step in which a coloring composition is prepared by mixing the dye fine particle dispersion with the polymer solution.

A fifth example of this method is a step in which a coloring composition is directly prepared by mixing into a solution containing at least water the oil-soluble dye, the ionic-group-containing polymer and the hydrophobic high-boiling-point organic solvent.

As an emulsifying apparatus used in the co-emulsifying dispersion method, there can be used a known apparatus such as a simple stirrer or an impeller stirring mode apparatus, inline stirring mode apparatus, mill mode apparatus like a colloid mill or the like, ultrasonic mode apparatus, or the like. Use of a high pressure homogenizer is particularly preferable. Detailed mechanisms of the high pressure homogenizer are described in U.S. Pat. No. 4,533,254, JP-A No. 6-47264 and the like and, as a commercially available apparatus, GAULIN HOMOGENIZER (A.P.V Gaulin Inc.), MICROFLUIDIZER (Microfluidex Inc.), ALTIMIZER (Sugino Machine K. K.) and the like can be used. Recently, a high pressure homogenizer equipped with a mechanism to form fine particles in an ultrahigh pressure jet flow as described in U.S. Pat. No. 5,720,551 is particularly effective for emulsifying dispersion of the present invention. DEBEE2000 (Bee International Ltd.) is used as an example of this emulsifying apparatus using an ultrahigh pressure jet flow.

Pressure when emulsifying by a high pressure emulsifying dispersion apparatus is generally 50 MPa or more, preferably 60 MPa or more, and further preferably 180 MPa or more. It is particularly preferable to use two or more emulsifying apparatuses together in a method, for example a method in which emulsification is conducted by a stirring emulsifier, then the emulsion is passed through a high pressure homogenizer. Further, a method in which emulsification is once conducted by such a emulsification apparatus, then additives such as a wetting agent, a surfactant and the like are added, then the emulsion is again passed through a high pressure homogenizer when a cartridge is being filled with ink is also a preferable method. When a low-boiling-point organic solvent is used in addition to the hydrophobic high-boiling-point organic solvent, it is preferable to remove the low-boiling-point organic solvent from the standpoints of stability and health and safety of an emulsion. For removing the low-boiling-point organic solvent, various known methods can be used depending on the type of the solvent. Namely, a vaporization method, vacuum vapor deposition method, ultrafiltration method and the like can be used. It is preferable to conduct a removal process of this low-boiling-point organic solvent as quickly as possible directly after emulsification.

Various surfactants can be used in emulsification dispersion. For example, anionic surfactants such as fatty acid salts, alkylsulfate salts, alkylbenzenesuccinate salts, alkylnaphthalenesulfonate salts, dialkylsulfosuccinate salts, alkylphosphate salts, naphthalenesulfonic acid formalin condensate, polyoxyethylenealkylsulfate salts and the like, and noionic surfactants such as polyoxyethylene alkyl ethers, polyoxyethylene alkylaryl ether, polyoxyethylene fatty acid esters, sorbitan fatty acid esters, polyoxyethylene sorbitan fatty acid esters, polyoxyethylene alkyl amines, glycerine fatty acid esters, oxyethylene oxypropylene block copolymers and the like, are preferable. Further, SURFYNOLS (Air Products & Chemicals), an acetylene-based polyoxyethylene oxide surfactant is also preferably used. Furthermore, amine oxide type ampholytic surfactants such as N,N-dimethyl-N-alkylamine oxide, and the like are also preferable. Further, surfactants listed in JP-A No. 59-157,636, pp. (37) to (38) and Research Disclosure No. 308119 (1989) can be used.

For obtaining stability directly after emulsification, a water-soluble polymer can also be added together with the above-mentioned surfactant. As the water-soluble polymer, polyvinyl alcohols, polyvinylpyrrolidone, polyethylene oxide, polyacrylic acid, polyacrylamide, and copolymers thereof are preferably used. Further, it is also preferable to use naturally occurring water-soluble polymers such as polysaccharides, casein, gelatin and the like.

When a coloring particulate containing the ionic-group-containing polymer, the oil-soluble dye and the hydrophobic high-boiling-point organic solvent is dispersed into a water-based medium to give ink, control of particle size is particularly important. To enhance color purity and concentration when images are formed by ink jet, it is preferable to reduce the average particle size. Specifically, the volume-average particle size of the coloring particulate is preferably 100 nm or less, and more preferably 1 nm or more and 80 nm or less. Further, when the above-mentioned coloring particulate contains coarse particles, printing ability may be decreased. For example, there may be adverse influences on printing abilities, such as a case in which coarse particles cause clogging in a head, a case in which discharge failure or discharge drip of ink is caused by formation of stains even though no clogging occurs, and the like. Therefore, an existence ratio of coarse particles is preferably low, and it is preferable that, when ink is prepared, 10 or less particles having a particle size of 5 μm or more and 1000 or less particles having a particle size of 1 μm or more are present in 1 μl of the ink. For removing coarse particles, a known centrifugal separation method, precision filtration method or the like can be utilized. These separation means may be conducted directly after emulsifying dispersion, or may be conducted after adding various additives such as a wetting agent, surfactant and the like to an emulsified dispersion and directly before charging the mixture into an ink cartridge. For decreasing the average particle size of a coloring particulate and reducing coarse particles, it is effective to use a mechanical emulsifying apparatus.

In the coloring composition of the present invention, the use amount of the ionic-group-containing polymer is preferably from 1 to 70% by mass and more preferably from 2 to 50% by mass, based on the sum of the oil-soluble dye, the ionic-group-containing polymer and the hydrophobic high-boiling-point organic solvent constituting the oil phase. If the use amount of the polymer is less than 1% by mass, maintenance of a fine and stable dispersion tends to become difficult with the passing of time. On the other hand, if over 70% by mass, the proportion of the hydrophobic high-boiling-point organic solvent in the coloring particulate dispersion decreases, and when the coloring particulate dispersion is used as water-based ink, a sinking property, particularly into high image quality recording paper, tends to lower.

In the coloring composition of the present invention, the content of the hydrophobic high-boiling-point organic solvent is from 25% by mass or more, preferably from 25 to 95% by mass, more preferably from 25 to 90% by mass, and most preferably from 25 to 85% by mass, based on the sum of the ionic-group-containing polymer, the oil-soluble dye, and the hydrophobic high-boiling-point organic solvent constituting the oil phase. When the use amount is less than 25% by mass, the penetration property of the ink into recording paper tends to lower. On the other hand, when the use amount of the hydrophobic high-boiling-point organic solvent is too high, a stable and fine dispersion tends to become difficult due to too high a proportion of the oil phase.

In the coloring composition of the present invention, the use amount of the oil-soluble dye is preferably from 1 to 70% by mass, and more preferably from 3 to 70% by mass, based on the sum of the ionic-group-containing polymer, the oil-soluble dye, and the hydrophobic high-boiling-point organic solvent constituting the oil phase.

—Organic solvent—

An organic solvent used other than the hydrophobic high-boiling-point organic solvent for preparation of the coloring composition is not particularly restricted, and can be appropriately selected based on solubility of the oil-soluble dye and the ionic-group-containing polymer, and the like. For example, there are listed ketone-based solvents such as acetone, methyl ethyl ketone, diethyl ketone and the like, alcohol-based solvents such as methanol, ethanol, 2-propanol, 1-propanol, 1-butanol, tert-butanol and the like, chlorine-based solvents such as chloroform, methylene chloride and the like, aromatic solvents such as benzene, toluene and the like, ester-based solvents such as ethyl acetate, butyl acetate, isopropyl acetate and the like, ether-based solvents such as diethyl ether, tetrahydrofuran, dioxane and the like, glycol ether-based solvents such as ethylene glycol monomethyl ether, ethylene glycol dimethylether and the like, and other solvents.

The organic solvent may be used alone or in a combination of two or more. A mixed solvent with water may also be used depending on solubility of the above-mentioned dye and polymer.

The use amount of the organic solvent is not particularly restricted providing it is in a range wherein the effect of the present invention does not disappear, and is preferably from 10 to 200 parts by mass, and more preferably from 100 to 1000 parts by mass based on 100 parts by mass of the ionic-group-containing polymer. When the use amount of the organic solvent is less than 10 parts by mass, a fine and stable dispersion of coloring particulate tends to become difficult, and when over 2000 parts by mass, processes of de-solution and concentration for removing the above-mentioned organic solvent become essential and complicated, and tolerances in composition design tend to disappear.

When solubility of the organic solvent in water is less than 10%, or when the vapor pressure of the organic solvent is larger than that of water, it is preferable that the organic solvent is removed from the standpoint of stability of the coloring particulate dispersion.

It is preferable that, after the coloring composition is prepared, the organic solvent is removed. Removal can be conducted under from atmospheric pressure to reduced pressure at 10 to 100° C., and preferably under atmospheric pressure at 40 to 100° C. or under reduced pressure at 10 to 50° C.

—Additive—

The coloring composition of the present invention may contain additives appropriately selected depending on objectives, within a range wherein the effect of the present invention does not disappear.

As the above-mentioned additives, for example, a neutralizing agent, dispersion stabilizer and the like are listed.

The neutralizing agent can be suitably used when the polymer has the ionic group in an un-neutralized condition, from the standpoints of pH control, self emulsifying property control, impartment of dispersion stability and the like of the coloring particulate dispersion. The neutralizing agent may be added when obtaining a polymer before preparation of a dispersion, or may be added in any process for conducting dispersion or after completion of dispersion. As an organic base usable as the neutralizing agent, triethanolamine, diethanolamine, N-methydiethanolamine, dimethylethanolamine and the like are listed as examples. As an inorganic alkali usable as the neutralizing agent, hydroxides of alkali metals (for example, sodium hydroxide, lithium hydroxide, potassium hydroxide and the like), carbonates of alkali metals (for example, sodium carbonate, sodium hydrogen carbonate and the like), ammonia and the like are listed as examples. The neutralizing agent is preferably added so as to give a pH from 4.5 to 10.0, and more preferably 6.0 to 10.0, from the standpoint of an increase in dispersion stability in the coloring particulate dispersion.

The above-mentioned dispersion stabilizer may be added to any of the above-mentioned oil phase and the above-mentioned water-based phase, and is preferably added after completion of emulsifying dispersion. As the dispersion stabilizer, examples include the above-mentioned cationic, anionic and nonionic various surfactants, water-soluble or water-dispersible compounds having a low molecular weight, oligomers and the like. The addition amount of the above-mentioned dispersion stabilizer is from 0 to 100% by mass, and preferably from 0 to 20% by mass based on the total amount of the oil-soluble dye and the ionic-group-containing polymer.

In the coloring composition of the present invention, the coloring particulate is contained preferably in an amount from 1 to 45% by mass, and more preferably in an amount of 2 to 30% by mass. The above-mentioned content can be appropriately controlled depending on dilution, evaporation, ultrafiltration and the like.

The coloring composition of the present invention can be used in various fields, and is suitable for a water-based ink for writing, water-based printing ink, information recording ink and the like, and can be used particularly suitably for an ink-jet ink of the present invention, described below.

(Ink-jet ink and ink-jet recording method)

The ink-jet ink of the present invention contains the above-mentioned coloring composition of the present invention, and other components appropriately selected as necessary.

In the ink-jet recording method of the present invention, recording is conducted using the above-mentioned ink-jet ink, and an ink nozzle and the like used in the recording are not particularly restricted, and can be appropriately selected depending on objectives.

The above-mentioned other components are contained in ranges wherein the effect of the present invention does not disappear.

As the above-mentioned other components, examples include known additives such as a drying prevention agent, permeation promoting agent, ultraviolet ray absorber, antioxidant, anti-fungus agent, pH controlling agent, surface tension controlling agent, de-foaming agent, viscosity controlling agent, dispersion stabilizer, rust-prevention agent, chelating agent and the like.

The above-mentioned drying prevention agent is suitably used for the purpose of inhibiting clogging that is due to drying of the above-mentioned ink-jet ink at an ink discharge port of a nozzle used in the ink-jet recording method.

As the above-mentioned drying prevention agent, a water-soluble organic solvent having a lower vapor pressure than that of water is preferable, and specific examples thereof include polyhydric alcohols, typified by ethylene glycol, propylene glycol, diethylene glycol, polyethylene glycol, thiodiglycol, dithiodiglycol, 2-methyl-1,3-propanediol, 1,2,6-hexanetriol, acetylene glycol derivatives, glycerine, trimethylolpropane and the like; lower alkyl ethers of polyhydric alcohol such as ethylene glycol monomethyl (or ethyl) ether, diethylene glycol monomethyl (or ethyl) ether, triethylene glycol monoethyl (or butyl) ether and the like; heterocyclic rings such as 2-pyrrolidone, N-methyl-2-pyrrolidone, 1,3-dimethyl-2-imidazolidinone, N-ethylmorpholine and the like; sulfur-containing compounds such as sulfolane, dimethylsulfoxide, 3-sulfolene and the like; polyfunctional compounds such as diacetone alcohol, diethanolamine and the like; and urea derivatives.

Of these, polyhydric alcohols such as glycerine, diethylene glycol and the like are more preferable. These drying prevention agents may be used alone or in a combination of two or more.

The content of the above-mentioned drying prevention agent in the above-mentioned ink-jet ink is preferably from 10 to 50% by mass.

The above-mentioned permeation promoting agent is suitably used for the purpose of more excellent permeation of the ink-jet ink into paper.

As the above-mentioned permeation promoting agent, there are listed, for example, alcohols such as ethanol, isopropanol, butanol, di(tri)ethylene glycol monobutyl ether, 1,2-hexanediol and the like, sodium laurylsulfate, sodium oleate, and nonionic surfactants and the like.

The above-mentioned permeation promoting agent is contained in an amount in a range wherein blotting of print, passing through paper (print through) and the like do not occur, and usually a sufficient effect is manifested when the permeation promoting agent is contained in an amount of about 5 to 30% by mass in the ink-jet ink.

The above-mentioned ultraviolet ray absorber is used for the purpose of improving storability of images.

As the above-mentioned ultraviolet ray absorber, there are listed, for example, benzotriazole-based compounds described in JP-A Nos. 58-185677, 61-190537, 2-782, 5-197075, 9-34057 and the like, benzophenone-based compounds described in JP-A Nos. 46-2784, 5-194483, U.S. Pat. No. 3,214,463 and the like, cinnamic acid-based compounds described in JP-B Nos. 48-30492, 56-21141, JP-A No. 10-88106 and the like, triazine compounds described in JP-A Nos. 4-298503, 8-53427, 8-239368, 10-182621, 8-501291 (PCT National Publication), and the like, compounds that emit fluorescence when absorbing ultraviolet rays, called fluorescent brighteners, typified by compounds described in Research Disclosure No. 24239, stilbene-based compounds and benzozazole-based compounds, and the like.

The above-mentioned antioxidant is used for the purpose of improving the storability of images.

As the above-mentioned antioxidant, examples that can be used include organic and metal complex-based discoloration preventing agents.

As the above-mentioned organic discoloration preventing agent, examples include hydroquinones, alkoxyphenols, dialkoxyphenols, phenols, anilines, amines, indanes, chromans, alkoxyanilines, heterocyclic rings and the like.

As the above-mentioned metal complex-based discoloration preventing agent, examples include a nickel complex, a zinc complex and the like, and specifically, there can be used compounds described in patents cited in Research Disclosure No. 17643, vol. VII, column I to J, No. 15162, No. 18716, page 650, left column, No. 36544, page 527, No. 307105, page 872 and No. 15162, and compounds included in examples and general formulae of typical compounds described in JP-A No. 62-215272, pp. 127 to 137.

As the above-mentioned anti-fungus agent, examples include dehydro sodium acetate, sodium benzoate, sodiumpyridienthione-l-oxide, ethyl p-hydroxybenzoate, 1,2-benzisothiazoline-3-one and salts thereof are listed. These are preferably used in an amount of 0.02 to 1.00% by mass in an ink.

As the above-mentioned pH controlling agent, the above-mentioned neutralizing agent (organic salt group or inorganic alkali) can be used. The above-mentioned pH controlling agent is added such that the above-mentioned ink-jet ink has a pH preferably of 6 to 10, and more preferably of 7 to 10, for the purpose of improving storage stability of the ink-jet ink.

As the above-mentioned surface tension controlling agent, nonionic, cationic or anionic surfactants are listed as examples.

The surface tension of the ink-jet ink of the present invention is preferably from 25 to 70 mN/m, and more preferably from 25 to 60 mN/m.

The viscosity of the ink-jet ink of the present invention is preferably 30 mPa·s or less, and more preferably 20 mPa·s or less.

As the above-mentioned defoaming agent, fluorine-based compounds and silicone-based compounds, and chelating agents typified by EDTA, and the like can also be used, if necessary.

The ink-jet ink of the present invention can be suitably printed on known recording materials, and the like. For example, normal paper, resin coated paper, ink-jet dedicated paper, films, general electrophotography paper, cloth, glass, metals, ceramics and the like are listed.

The above-mentioned recording material is not particularly restricted, and ink-jet dedicated paper is preferable.

As the above-mentioned ink-jet dedicated paper, examples include those described in JP-A Nos. 8-169172, 8-27693, 2-276670, 7-276789, 9-323475, 62-238783, 10-153989, 10-217473, 10-235995, 10-337947, 10-217597, 10-337947 and the like.

In the present invention, there are suitably used the following recording paper and recording film, in addition to the above-mentioned ink-jet dedicated paper, as the above-mentioned recording material.

The recording paper or recording film has a substrate with an ink receiving layer laminated thereon and, if necessary, has other layers such as a back coat layer and the like laminated thereto.

The layers typically including an ink receiving layer may be used each in a single layer, or in two or more layers.

As the above-mentioned substrate, examples include those made of chemical pulp such as LBKP, NBKP and the like, those made of mechanical pulp such as GP, PGW, RMP, TMP, CTMP, CMP CGP and the like, and those made of waste pulp such as DIP and the like. In the above-mentioned pulp, conventionally known pigments, binders, sizing agents, fixing agents, cationic agents, paper strength reinforcing agents and the like may be added and mixed as necessary. The above-mentioned substrate can be formed by using various apparatuses such as a long net paper machine, round net paper machine or the like.

The above-mentioned substrate may further be synthetic paper, plastic film sheet and the like.

The thickness of the above-mentioned substrate is from about 10 to 250 μm, and the basic weight is desirably from 10 to 250 g/m².

On the substrate, the ink receiving layer, and further the back coat layer selected as necessary, may be directly laminated, or the above-mentioned ink receiving layer and the above-mentioned back coat layer may be provided after a size press or anchor coat layer is formed of starch, polyvinyl alcohol or the like.

Further, on the substrate, a flattening treatment may be performed by a calendering machine such as a machine calender, TG calender, soft calender or the like.

Of the above-mentioned substrates, paper and plastic films laminated on both surfaces with a polyolefin (for example, polyethylene, polystyrene, polyethylene terephthalate, polybutene, or a copolymer thereof) are preferable, and it is more preferable that a white pigment (for example, titanium oxide, zinc oxide) or coloring dyer (for example, cobalt blue, ultramarine, neodymium oxide) is added in the above-mentioned polyolefin.

The above-mentioned ink receiving layer contains a pigment, water-based binder, mordanting agent, water resistant agent, light resistance improving agent, surfactant, and other additives.

As the pigment, a white pigment is preferable.

As the white pigment, there are listed, for example, inorganic white pigments such as calcium carbonate, kaolin, talc, clay, diatomaceous earth, synthetic amorphous silica, aluminum silicate, magnesium silicate, calcium silicate, aluminum hydroxide, alumina, lithopone, zeolite, barium sulfate, calcium sulfate, titanium dioxide, zinc sulfate, zinc carbonate and the like; and organic pigments such as styrene-based pigments, acrylic pigments, urea resins, melamine resins and the like.

Of these, porous inorganic pigments are preferable, and a synthetic amorphous silica having a large fine pore area or the like is particularly preferable.

As the above-mentioned synthetic amorphous silica, any of anhydrous silic acid obtained by a dry production method and water-containing silic acid obtained by a wet production method can be used, and water-containing silic acid is particularly preferable.

As the above-mentioned water-based binder, there are listed, for example, water-soluble polymers such as polyvinyl alcohol, silanol-modified polyvinyl alcohol, starch, cationized starch, casein, gelatin, carboxymethylcellulose, hydroxyethylcellulose, polyvinylpyrrolidone, polyalkylene oxide, polyalkylene oxide derivatives, and the like; and water-dispersible polymers such as styrene butadiene latex, acryl emulsion and the like.

These may be used alone or in a combination of two or more.

Of these, polyvinyl alcohol and silanol-modified polyvinyl alcohol are preferable from the standpoints of adhesion to the pigment and an anti-peeling property of the ink receiving layer.

The mordanting agent is preferably immobilized and, therefore, a polymer mordanting agent is preferable.

Regarding the above-mentioned polymer mordanting agent, examples are described in JP-A Nos. 48-28325, 54-74430, 54-124726, 55-22766, 55-142339, 60-23850, 60-23851, 60-23852, 60-23853, 60-57836, 60-60643, 60-118834, 60-122940, 60-122941, 60-122942, 60-235134, and 1-161236, and U.S. Pat. Nos. 2,484,430, 2,548,564, 3,148,061, 3,309,690, 4,115,124, 4,124,386, 4,193,800, 4,273,853, 4,282,305, and 4,450,224. Polymer mordanting agents described in JP-A No. 1-161236, pp. 212 to 215 are suitably listed as examples. When these polymer mordanting agents are used, an image having excellent image quality is obtained, and light resistance of the image is improved, which is preferable.

The above-mentioned water resistant agent is used for the purpose of rendering an image water-resistant.

A cationic resin is preferable as the water-resistant agent.

As the cationic resin, there are listed, for example, polyamidepolyamineepichlorohydrin, polyethyleneimine, polyamineslfone, dimethyldiallylammonium chloride polymer, cation polyacrylamide and the like. Of these cationic resins, polyamidepolyamineepichlorohydrin is particularly preferable.

The content of the cationic resin is preferably from 1 to 15% by mass, and more preferably from 3 to 10% by mass based on the total solid component of the ink receiving layer.

As the light resistance improving agent, there are listed, for example, zinc sulfate, zinc oxide, hindered amine-based antioxidant, benzotriazole-based ultraviolet ray absorbers such as benzophenone and the like. Of these, zinc sulfate is particularly preferable.

The above-mentioned surfactant functions as a coating aid, peeling property improving agent, sliding property improving agent or antistatic agent.

As the surfactant, those described in JP-A Nos. 62-173463, 62-183457 are listed as examples.

An organic fluoro compound may be used instead of the surfactant.

The above-mentioned fluoro compound is preferably hydrophobic.

The fluoro compound includes, for example, a fluorine surfactant, oily fluorine compound (for example, fluorine oil) and a solid fluorine compound resins (for example, ethylene tetrafluoride resin), and examples include those described in JP-B No. 57-9053 (columns 8 to 17), and JP-A Nos. 61-20994 and 62-135826.

As the above-mentioned other additives, there are listed, for example, pigment dispersing agents, thickening agents, defoaming agents, dyes, fluorescent brighteners, preservatives, pH controlling agents, matting agents, film hardening agents and the like.

The back coat layer contains a white pigment, water-based binder, and other components.

As the white pigment, there are listed, for example, inorganic white pigments such as light calcium carbonate, heavy calcium carbonate, kaolin, talc, clay, calcium sulfate, barium sulfate, titanium dioxide, zinc oxide, zinc sulfate, zinc carbonate, satin white, aluminum silicate, diatomaceous earth, calcium silicate, magnesium silicate, synthetic amorphous silica, colloidal silica, colloidal alumina, pseudo bohemite, aluminum hydroxide, alumina, lithopone, zeolite, water-added halloysite, magnesium carbonate, magnesium hydroxide and the like; and organic pigments such as styrene-based plastic pigments, acrylic plastic pigments, polyethylene, microcapsule, urea resins, melamine resins and the like.

As the above-mentioned water-based binder, there are listed, for example, water-soluble polymers such as styrene/maleic acid salt copolymer, styrene/acrylic acid salt copolymer, polyvinyl alcohol, silanol-modified polyvinyl alcohol, starch, cationized starch, casein, gelatin, carboxymethylcellulose, hydroxyethylcellulose, polyvinylpyrrolidone, and the like; and water-dispersible polymers such as styrene butadiene latex, acryl emulsion and the like.

As the above-mentioned other components, examples include defoaming agents, foaming suppressing agents, dyes, fluorescent brighteners, preservatives, water resistance imparting agents and the like.

A polymer latex may be added to each layer of the above-mentioned recording paper or recording film.

The polymer latex is used for the purpose of improving film physical properties such as dimension stability, curl prevention, adhesion prevention, and film cracking prevention.

As the polymer latex, examples include those described in JP-A Nos. 62-245258, 62-136648 and 62-110066. If a polymer latex having a low glass transition temperature (40° C. or less) is added to a layer containing the above-mentioned mordanting agent, cracking and curl of the layer can be prevented. Further, if a polymer latex having a high glass transition temperature is added to the above-mentioned back coat layer, curl can be prevented.

In the ink-jet recording method of the present invention, the recording medium used is not restricted, and if a recording medium having a substrate on which is laminated an ink receiving layer containing white pigment is used as the recording medium, the formed image obtains high image quality, which is preferable. In the case of a conventional ink, there is a problem that, when recording paper having an ink receiving layer containing a porous inorganic pigment such as a white pigment or the like is used, the sinking property into the recording paper is poor, and when the formed image is rubbed with a hand, dye is peeled off from the surface. In the case of the ink of the present invention, such a problem has been solved since the sinking property is excellent. Therefore, when the above-mentioned recording medium is used, an image having high image quality and high strength can be formed.

The ink-jet ink of the present invention can be applied to any ink-jet recording method, and suitably used for, for example, an electric charge controlling method in which ink is discharged by utilizing an electrostatic attracting force, a drop-on-demand method (pressure pulse method) utilizing vibration pressure of a piezo element, an acoustic ink-jet method in which an electric signal is converted into an acoustic beam, ink is irradiated with this beam and the ink is discharged by utilizing radiation pressure, a thermal ink-jet (bubble jet) method in which ink is heated to form bubbles, and generated pressure is utilized, and the like.

The ink-jet recording method includes a method in which an ink having a lower concentration, called a photo ink, is discharged though a lot of ports in small volume, a method in which an image is improved by using a plurality of inks having substantially the same hue and different concentrations, and a method using a colorless, transparent ink.

The present invention will be illustrated below by Examples, but these do not limit the scope of the present invention.

### EXAMPLE 1

Production of Ink Set 101

8 g of an above-mentioned magenta dye (exemplified compound M-6) and, 2 g of an ionic-group-containing polymer (P-11) were dissolved in 6 g of an hydrophobic high-boiling-point organic solvent (exemplified compound S-2), 10 g of another hydrophobic high-boiling-point organic solvent (exemplified compound S-11), 2.5 g of sodium dioctylsulfosuccinate and 50 ml of ethyl acetate at 70° C. Into this solution was added 500 ml of deionized water while stirring with a magnetic stirrer, to produce a coarse particle dispersion of oil-in-water type. Into this mixed solution was added a 2 mol/liter sodium hydroxide water-based solution until acidity of the ionic-group-containing polymer was neutralized.

Next, this coarse particle dispersion was processed into fine particles by passing through a MICROFLUIDIZER (Microfluidex Inc) under a pressure of 60 MPa five times. Further, a resulting emulsion was processed in a rotary evaporator to remove the solvent until odor of ethyl acetate disappeared, to obtain a coloring particulate dispersion.

To the resulting coloring composition were added additives such as diethylene glycol, glycerine, SURFYNOL465 (Air Products & Chemicals), and urea and the like, then, deionized water was added and pH was controlled to 9 using 1 mol/l KOH, to give a light magenta ink for an ink-jet ink. The composition of materials used in production of the resulting light magenta ink is shown in the following Table 1. Numerical values in Table 1 represent the content of each material per 1 liter of the ink. The volume-average particle size of the coloring particulate was measured by using MICRO TRACK UPA (Nikkiso K. K.) and found to be 26 nm.

In production of the above-mentioned light magenta ink, dye species used, the amount of the hydrophobic high-boiling-point organic solvent, the amount of the ionic-group-containing polymer and the amount of SURFYNOL465 were changed as shown in Table 1, to produce a magenta ink, light cyan ink, cyan ink, yellow ink and black ink, respectively, and an ink set 101 composed of 6 inks was obtained.

TABLE 1

| | Light | | | | | | | | | | | |
|---|---|---|---|---|---|---|---|---|---|---|---|---|
| | magenta ink | | Magenta ink | | Light cyan ink | | Cyan ink | | Yellow ink | | Black ink | |
| Dye | M-6 5.00 | g | M-6 20.0 | g | C-1 9.3 | g | C-1 37.2 | g | YY-1 27.2 | g | M-6 10.0 | g |
| | | | | | | | | | | | C-1 18.6 | g |
| | | | | | | | | | | | YY-1 13.6 | g |
| Higher boiling point organic | S-2 3.63 | g | S-2 14.52 | g | S-2 6.75 | g | S-2 27.0 | g | S-2 19.74 | g | S-2 30.6 | g |
| solvent | S-11 6.38 | g | S-11 25.52 | g | S-11 11.9 | g | S-11 47.6 | g | S-11 34.7 | g | S-11 53.8 | g |
| Ionic group-containing polymer | P-11 1.25 | g | P-11 5.0 | g | P-11 2.33 | g | P-11 9.3 | g | P-11 6.8 | g | P-11 10.6 | g |
| Sodium dioctylsulfosuccinate | 3.13 | g | 12.5 | g | 11.6 | g | 46.4 | g | 34.0 | g | 52.7 | g |
| Diethylene glycol | 110.0 | g | 110.0 | g | 110.0 | g | 110.0 | g | 110.0 | g | 110.0 | g |
| Urea | 46.0 | g | 46.0 | g | 46.0 | g | 46.0 | g | 46.0 | g | 46.0 | g |
| Glycerin | 50.0 | g | 50.0 | g | 50.0 | g | 50.0 | g | 50.0 | g | 50.0 | g |
| Surfinol 465 | 5.5 | g | 5.5 | g | 5.5 | g | 5.5 | g | 5.5 | g | 5.5 | g |
| Triethanolamine | 7.5 | g | 7.5 | g | 7.5 | g | 7.5 | g | 7.5 | g | 7.5 | g |
| Benzotriazole | 0.075 | g | 0.075 | g | 0.075 | g | 0.075 | g | 0.075 | g | 0.075 | g |
| Preservative Proxel XL2 | 2.5 | g | 2.5 | g | 2.5 | g | 2.5 | g | 2.5 | g | 2.5 | g |
| Volume-average particle size | 26 | nm | 33 | nm | 28 | nm | 35 | nm | 35 | nm | 44 | nm |

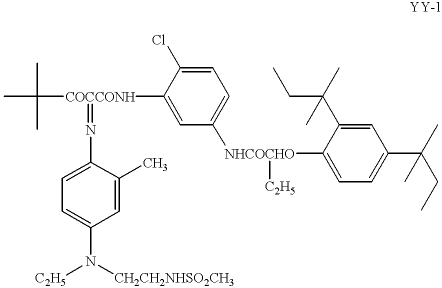

<Production of Ink Sets 102 to 113>

Next, in production of Ink set 101, kinds and amounts of the oil-soluble dye, ionic-group-containing polymer and hydrophobic high-boiling-point organic solvent were changed as shown in the following Tables 2 to 5, to produce Ink sets 104 to 107 and 110 to 112. Comparative Examples 102 and 108 were obtained by removing only the ionic-group-containing polymer from Ink sets 101 and 107, respectively, and Comparative Examples 103 and 109 were obtained by reducing the used amount of the hydrophobic high-boiling-point organic solvent from Ink sets 101 and 107, respectively, to 15% based on the total amount of the ionic-group-containing polymer and the oil-soluble dye. Further, Ink set 113 was prepared as shown in Table 6 as an ink set for comparison by using a water-soluble dye.

TABLE 2

| Ink set | | Light magenta ink | Magenta ink | Light cyan ink | Cyan ink | Yellow ink | Black ink | Remarks |
|---|---|---|---|---|---|---|---|---|
| 101 | Dye | M-6 5.00 g | M-6 20.0 g | C-1 9.3 g | C-1 37.2 g | YY-1 27.2 g | M-6 10.0 g | Example |
| | | | | | | | C-1 18.6 g | |
| | | | | | | | YY-1 13.6 g | |
| | Higher boiling point organic | 3.63 g/6.38 g | 14.52 g/25.52 g | 6.75 g/11.9 g | 27.0 g/47.6 g | 19.7 g/34.7 g | 30.6 g/53.8 g | |
| | solvent S-2/S-11 | | | | | | | |
| | Ionic group-containing | P-11 1.25 g | P-11 5.0 g | P-11 2.33 g | P-11 9.3 g | P-11 6.8 g | P-11 10.6 g | |
| | polymer | | | | | | | |
| | Volume-average particle | 26 nm | 33 nm | 28 nm | 35 nm | 35 nm | 44 nm | |
| | size | | | | | | | |
| 102 | Dye | M-6 5.00 g | M-6 20.0 g | C-1 9.3 g | C-1 37.2 g | YY-1 27.2 g | M-6 10.0 g | Comparative |
| | | | | | | | C-1 18.6 g | Example |
| | | | | | | | YY-1 13.6 g | |
| | Higher boiling point organic | 3.63 g/6.38 g | 14.52 g/25.52 g | 6.75 g/11.9 g | 27.0 g/47.6 g | 19.7 g/34.7 g | 30.6 g/53.8 g | |
| | solvent S-2/S-11 | | | | | | | |
| | Ionic group-containing | — | — | — | — | — | — | |
| | polymer | | | | | | | |
| | Volume-average particle | 45 nm | 55 nm | 52 nm | 72 nm | 63 nm | 85 nm | |
| | size | | | | | | | |
| 103 | Dye | M-6 5.00 g | M-6 20.0 g | C-1 9.3 g | C-1 37.2 g | YY-1 27.2 g | M-6 10.0 g | Comparative |
| | | | | | | | C-1 18.6 g | Example |
| | | | | | | | YY-1 13.6 g | |
| | Higher boiling point organic | 0.81 g/1.42 g | 3.26 g/5.73 g | 1.51 g/2.66 g | 6.06 g/10.7 g | 4.42 g/7.77 g | 6.87 g/12.1 g | |
| | solvent S-2/S-11 | | | | | | | |
| | Ionic group-containing | P-11 10.0 g | P-11 40.0 g | P-11 18.6 g | P-11 74.6 g | P-11 54.6 g | P-11 84.4 g | |
| | polymer | | | | | | | |
| | Volume-average particle | 29 nm | 36 nm | 33 nm | 37 nm | 39 nm | 42 nm | |
| | size | | | | | | | |

TABLE 3

| Ink set | | Light magenta ink | Magenta ink | Light cyan ink | Cyan ink | Yellow ink | Black ink | Remarks |
|---|---|---|---|---|---|---|---|---|
| 104 | Dye | M-6 5.00 g | M-6 20.0 g | C-1 9.3 g | C-1 37.2 g | YY-1 27.2 g | M-6 10.0 g | Example |
| | | | | | | | C-1 18.6 g | |
| | | | | | | | YY-1 13.6 g | |
| | Higher boiling point organic | 3.63 g/6.38 g | 14.52 g/25.52 g | 6.75 g/11.9 g | 27.0 g/47.6 g | 19.7 g/34.7 g | 30.6 g/53.8 g | |
| | solvent S-2/S-11 | | | | | | | |
| | Ionic group-containing | P-36 1.25 g | P-36 5.0 g | P-36 2.33 g | P-36 9.3 g | P-36 6.8 g | P-36 10.6 g | |
| | polymer | | | | | | | |
| | Volume-average particle | 30 nm | 34 nm | 29 nm | 36 nm | 38 nm | 46 nm | |
| | size | | | | | | | |
| 105 | Dye | M-6 5.00 g | M-6 20.0 g | C-1 9.3 g | C-1 37.2 g | YY-1 27.2 g | M-6 10.0 g | Example |
| | | | | | | | C-1 18.6 g | |
| | | | | | | | YY-1 13.6 g | |
| | Higher boiling point organic | 3.63 g/6.38 g | 14.52 g/25.52 g | 6.75 g/11.9 g | 27.0 g/47.6 g | 19.7 g/34.7 g | 30.6 g/53.8 g | |
| | solvent S-2/S-11 | | | | | | | |
| | Ionic group-containing | P-13 10 g | P-13 4.0 g | P-13 1.86 g | P-13 7.44 g | P-13 5.44 g | P-13 8.48 g | |
| | polymer | P-63 1.0 g | P-63 4.0 g | P-63 1.86 g | P-63 7.44 g | P-63 5.44 g | P-63 8.48 g | |
| | Volume-average particle | 27 nm | 31 nm | 29 nm | 34 nm | 34 nm | 40 nm | |
| | size | | | | | | | |
| 106 | Dye | M-6 5.00 g | M-6 20.0 g | C-1 9.3 g | C-1 37.2 g | YY-1 27.2 g | M-6 10.0 g | Example |
| | | | | | | | C-1 18.6 g | |
| | | | | | | | YY-1 13.6 g | |
| | Higher boiling point organic | 4.0 g/6.0 g | 16.0 g/24.0 g | 7.44 g/11.2 g | 25.8 g/38.8 g | 21.8 g/32.6 g | 33.7 g/50.6 g | |
| | solvent S-9/S-24 | | | | | | | |
| | Ionic group-containing | P-12 1.25 g | P-12 5.0 g | P-12 2.33 g | P-12 9.3 g | P-12 6.8 g | P-12 10.6 g | |
| | polymer | | | | | | | |
| | Volume-average particle | 32 nm | 33 nm | 35 nm | 38 nm | 37 nm | 47 nm | |
| | size | | | | | | | |

TABLE 4

| Ink set | | Light magenta ink | Magenta ink | Light cyan ink | Cyan ink | Yellow ink | Black ink | Remarks |
|---|---|---|---|---|---|---|---|---|
| 107 | Dye | MM-2 3.6 g | MM-2 14.4 g | CC-2 17.4 g | CC-2 69.6 g | YY-2 26.5 g | MM-2 6.5 g | Example |
| | | | | | | | CC-2 34.8 g | |
| | | | | | | | YY-2 13.3 g | |
| | Higher boiling point organic | 2.6 g/4.6 g | 10.5 g/18.5 g | 12.6 g/22.1 g | 50.5 g/88.7 g | 19.2 g/33.7 g | 39.6 g/69.6 g | |
| | solvent S-2/S-11 | | | | | | | |
| | Ionic group-containing | P-6 0.9 g | P-6 3.6 g | P-6 4.35 g | P-6 17.4 g | P-6 6.6 g | P-6 13.7 g | |
| | polymer | | | | | | | |
| | Volume-average particle | 30 nm | 33 nm | 37 nm | 49 nm | 36 nm | 46 nm | |
| | size | | | | | | | |
| 108 | Dye | MM-2 3.6 g | MM-2 14.4 g | CC-2 17.4 g | CC-2 69.6 g | YY-2 26.5 g | MM-2 6.5 g | Comparative |
| | | | | | | | CC-2 34.8 g | Example |
| | | | | | | | YY-2 13.3 g | |
| | Higher boiling point organic | 2.6 g/4.6 g | 10.5 g/18.5 g | 12.6 g/22.1 g | 50.5 g/88.7 g | 19.2 g/33.7 g | 39.6 g/69.6 g | |
| | solvent S-2/S-11 | | | | | | | |
| | Ionic group-containing | — | — | — | — | — | — | |
| | polymer | | | | | | | |
| | Volume-average particle | 40 nm | 48 nm | 50 nm | 105 nm | 74 nm | 93 nm | |
| | size | | | | | | | |
| 109 | Dye | MM-2 3.6 g | MM-2 14.4 g | CC-2 17.4 g | CC-2 69.6 g | YY-2 26.5 g | MM-2 6.5 g | Comparative |
| | | | | | | | CC-2 34.8 g | Example |
| | | | | | | | YY-2 13.3 g | |
| | Higher boiling point organic | 0.59 g/1.03 g | 2.3 g/4.05 g | 2.84 g/5.0 g | 11.4 g/20.0 g | 4.33 g/7.61 g | 8.92 g/15.7 g | |
| | solvent S-2/S-11 | | | | | | | |
| | Ionic group-containing | P-6 7.2 g | P-6 28.8 g | P-6 34.8 g | P-6 139.2 g | P-6 53.0 g | P-6 109.2 g | |
| | polymer | | | | | | | |
| | Volume-average particle | 22 nm | 29 nm | 33 nm | 44 nm | 35 nm | 42 nm | |
| | size | | | | | | | |

TABLE 5

| Ink set | | Light magenta ink | Magenta ink | Light cyan ink | Cyan ink | Yellow ink | Black ink | Remarks |
|---|---|---|---|---|---|---|---|---|
| 110 | Dye | MM-2 3.6 g | MM-2 14.4 g | CC-2 17.4 g | CC-2 69.6 g | YY-2 26.5 g | MM-2 6.5 g | Example |
| | | | | | | | CC-2 34.8 g | |
| | | | | | | | YY-2 13.3 g | |
| | Higher boiling point organic | 2.6 g/4.6 g | 10.5 g/18.5 g | 12.6 g/22.1 g | 50.5 g/88.7 g | 19.2 g/33.7 g | 39.6 g/69.6 g | |
| | solvent S-2/S-11 | | | | | | | |
| | Ionic group-containing | P-10 0.72 g | P-10 2.88 g | P-10 3.48 g | P-10 13.9 g | P-10 5.3 g | P-10 10.9 g | |
| | polymer | P-63 0.72 g | P-63 2.88 g | P-63 3.48 g | P-63 13.9 g | P-63 5.3 g | P-63 10.9 g | |
| | Volume-average particle | 25 nm | 34 nm | 36 nm | 45 nm | 38 nm | 42 nm | |
| | size | | | | | | | |
| 111 | Dye | MM-2 3.6 g | MM-2 14.4 g | CC-2 17.4 g | CC-2 69.6 g | YY-2 26.5 g | MM-2 6.5 g | Example |
| | | | | | | | CC-2 34.8 g | |
| | | | | | | | YY-2 13.3 g | |
| | Higher boiling point organic | 2.6 g/4.6 g | 10.5 g/18.5 g | 12.6 g/22.1 g | 50.5 g/88.7 g | 19.2 g/33.7 g | 39.6 g/69.6 g | |
| | solvent S-2/S-11 | | | | | | | |
| | Ionic group-containing | P-93 0.9 g | P-93 3.6 g | P-93 4.35 g | P-93 17.4 g | P-93 6.6 g | P-93 13.7 g | |
| | polymer | | | | | | | |
| | Volume-average particle | 32 nm | 36 nm | 41 nm | 59 nm | 46 nm | 58 nm | |
| | size | | | | | | | |
| 112 | Dye | MM-3 3.6 g | MM-3 14.4 g | CC-3 17.4 g | CC-3 69.6 g | YY-2 26.5 g | MM-3 6.5 g | Example |
| | | | | | | | CC-3 34.8 g | |
| | | | | | | | YY-2 13.3 g | |
| | Higher boiling point organic | 2.88 g/4.32 g | 11.5 g/17.3 g | 13.9 g/20.9 g | 55.7 g/83.5 g | 21.2 g/31.8 g | 43.6 g/65.5 g | |
| | solvent S-9/S-24 | | | | | | | |
| | Ionic group-containing | P-85 0.9 g | P-85 3.6 g | P-85 4.35 g | P-85 17.4 g | P-85 6.6 g | P-85 13.7 g | |
| | polymer | | | | | | | |
| | Volume-average particle | 37 nm | 44 nm | 47 nm | 75 nm | 52 nm | 66 nm | |
| | size | | | | | | | |

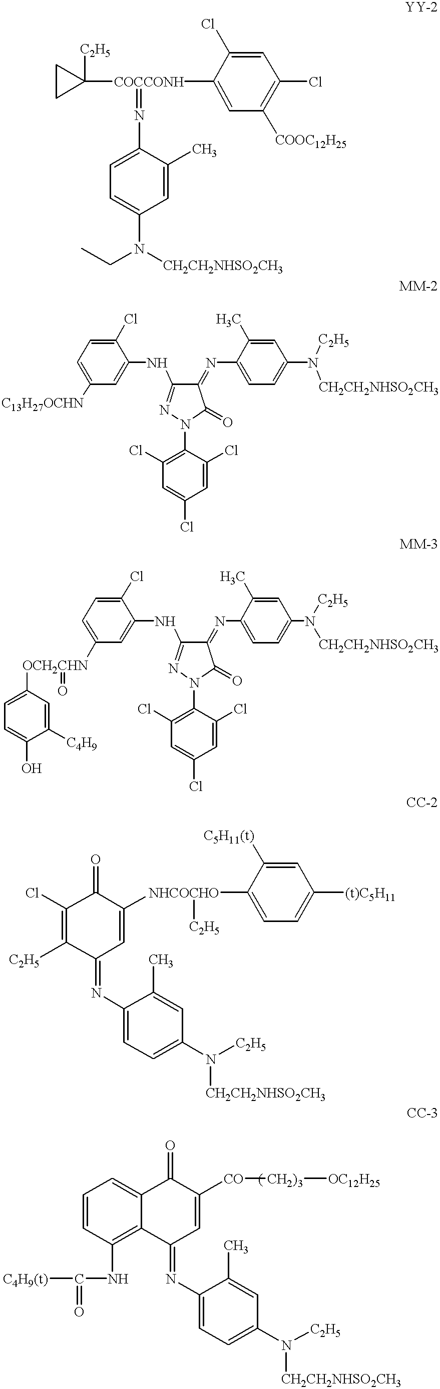 TABLE 6

| | Light | | | | | | | | | | | |
|---|---|---|---|---|---|---|---|---|---|---|---|---|
| | magenta ink | | Magenta ink | | Light cyan ink | | Cyan ink | | Yellow ink | | Black ink | |
| Dye | A-1 7.0 | g | A-1 28.0 | g | A-2 8.75 | g | A-2 35.0 | g | A-3 14.7 | g | A-5 20.0 | g |
| | | | | | | | | | A-4 14.0 | g | A-6 20.0 | g |
| | | | | | | | | | | | A-1 20.0 | g |
| | | | | | | | | | | | A-3 21.0 | g |
| Diethylene glycol | 150.0 | g | 110.0 | g | 130.0 | g | 200.0 | g | 160.0 | g | 20.0 | g |
| Urea | 37.0 | g | 46.0 | g | — | | — | | — | | — | |
| Glycerin | 130.0 | g | 130.0 | g | 150.0 | g | 180.0 | g | 150.0 | g | 120.0 | g |
| Triethylene glycol monobutyl ether | 130.0 | g | 140.0 | g | 130.0 | g | 140.0 | g | 130.0 | g | — | |
| Diethylene glycol monobutyl ether | — | | — | | — | | — | | — | | 230.0 | g |
| 2-Pyrrolidone | — | | — | | — | | — | | — | | 80.0 | g |
| Surfinol 465 | 10.5 | g | 11.5 | g | 11.1 | g | 9.8 | g | — | | — | |
| Surfinol TG | — | | — | | — | | — | | 9.0 | g | 8.5 | g |
| Triethanolamine | 6.9 | g | 7.4 | g | 6.8 | g | 6.7 | g | 0.8 | g | 17.9 | g |
| Benzotriazole | 0.08 | g | 0.07 | g | 0.08 | g | 0.08 | g | 0.06 | g | 0.06 | g |
| Preservative Proxel XL2 | 3.5 | g | 2.5 | g | 1.8 | g | 2.0 | g | 2.5 | g | 1.8 | g |

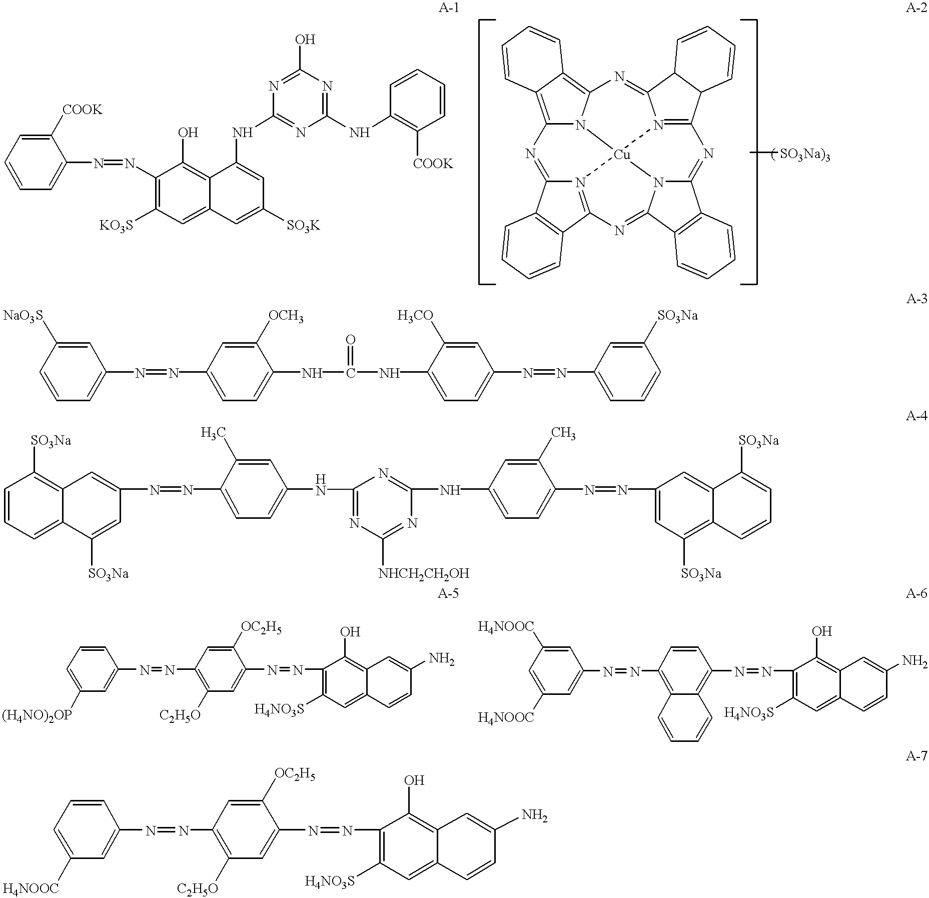

Next, the produced Ink sets 101 to 113 were filled into a cartridge of an ink-jet printer, PM670C (manufactured by EPSON), images were printed on ink-jet paper, photo gloss paper EX (recording paper in which an ink receiving layer contains a white pigment) manufactured by Fuji Photo Film Co., Ltd,. using the same machine, and the following evaluations were conducted. The evaluation results are shown in the following Tables 7 and 8.

Evaluation of printing ability (1)

The cartridge was set in the printer, discharge of an ink from all nozzles was confirmed, and then images were output on 20 pieces of A4 paper and disturbance of printing was evaluated according to the following standards.

A: No disturbance from initiation to completion of printing.

B: Some disturbances occurred at some times from initiation to completion of printing.

C: Disturbances occurred from initiation to completion of printing.

Evaluation of printing ability (2)

The cartridge was left at room temperature to 60° C. for 3 days, and then disturbance of printing was evaluated according to the same standards as in Evaluation of printing ability (1).

Evaluation of drying property

Images were printed in the same manner as described above and, immediately, the image parts were touched with a finger; generated staining was evaluated visually. “◯” in the drying property column in Table 7 indicates that no stain was generated. Evaluation of blotting of narrow lines

Narrow line patterns of yellow, magenta, cyan and black were printed, and evaluated visually (Evaluation of blotting of narrow lines (1)). For black, a magenta ink was printed in solid condition, then, black narrow lines were printed, and blotting by contact of the two colors was evaluated (Evaluation of blotting of narrow lines (2)). “◯” in the columns of blotting of narrow lines (1) and (2) in Table 7 indicates that no blotting was recognized, and “Δ” indicates that slight blotting was recognized.

Evaluation of water resistance

Images formed in the same manner were immersed in deionized water for 10 seconds, then blotting generated on image parts was evaluated visually. “◯” in the water resistance column indicates that no blotting occurred, and “X” indicates that blotting occurred.

Evaluation of over abrasion

Images were printed in the same manner, left for 30 minutes, and abraded with a rubber eraser, and presence or absence of change in concentration of image parts was visually evaluated. In Table 7, “A” in the column of over abrasion indicates an excellent result in which change in concentration was scarcely recognized, and “B” indicates a bad result in which change in concentration was recognized.

Evaluation of paper dependency of hue

Images were formed on the above-mentioned photo gloss paper and normal paper for PPC, respectively, hues on both image parts were compared, and evaluated into two levels, namely, when hue difference was small, “A”, and when hue difference was large, “B”.

Regarding storability of images, print samples of Yellow (Y), Magenta (M), Cyan (C) and Black (BK) were produced, respectively, and light fastness and dark heat storability were evaluated as follows.

Evaluation of light fastness

Image concentration Ci directly after printing was measured with X-RITE 310, then the image was irradiated with a xenon light (85000 lux) for 5 days using WEATHER-O-METER manufactured by Atlas. Then the image concentration Cf was measured again, and the pigment remaining ratio Cf/Ci×100 was measured and evaluated. The pigment remaining ratio was evaluated at 3 points with reflection concentration levels of 1, 1.5 and 2 and A in which the pigment remaining ratio was 80% or more at every concentration is represented by “A”, a case in which the pigment remaining ratio was less than 80% at two levels is represented by “B”, and a case in which the pigment remaining ratio was less than 80% at all levels is represented by “C”.

Evaluation of dark heat storability

The image concentration of the print sample was measured with C-RITE 310 before and after storage for 7 days under a condition of 80 to 70% RH, and the pigment remaining ratio was calculated. The pigment remaining ratio was evaluated at 3 reflection concentration levels of 1, 1.5 and 2. A case in which the pigment remaining ratio was 90% or more at every concentration is represented by “A”, a case in which the pigment remaining ratio was less than 90% at two levels is represented by “B”, and a case in which the pigment remaining ratio was less than 90% at all levels is represented by “C”.

TABLE 7

| | Print- | Print- | Dry- | Blotting | Blotting | | | Paper |
|---|---|---|---|---|---|---|---|---|
| | ing | ing | ing | of | of | Water | Over | de- |
| Ink | abili- | abili- | prop- | narrow | narrow | resist- | abrasion | pend- |
| set | ty (1) | ty (2) | erty | lines (1) | lines (2) | ance | property | ency |
| 101 | A | A | ◯ | ◯ | ◯ | ◯ | A | ◯ |
| 102 | A | B | ◯ | ◯ | ◯ | ◯ | A | ◯ |
| 103 | A | B | ◯ | ◯ | ◯ | ◯ | B | ◯ |
| 104 | A | A | ◯ | ◯ | ◯ | ◯ | A | ◯ |
| 105 | A | A | ◯ | ◯ | ◯ | ◯ | A | ◯ |
| 106 | A | A | ◯ | ◯ | ◯ | ◯ | A | ◯ |
| 107 | A | B | ◯ | ◯ | ◯ | ◯ | A | ◯ |
| 108 | A | B | ◯ | ◯ | ◯ | ◯ | A | ◯ |
| 109 | A | B | ◯ | ◯ | ◯ | ◯ | B | ◯ |
| 110 | A | B | ◯ | ◯ | ◯ | ◯ | A | ◯ |
| 111 | A | B | ◯ | ◯ | ◯ | ◯ | A | ◯ |
| 112 | A | B | ◯ | ◯ | ◯ | ◯ | A | ◯ |
| 113 | A | A | ◯ | Δ | Δ | X | A | X |

TABLE 8

| Ink | Light fastness | | | | Humidity heat fastness | | | |
|---|---|---|---|---|---|---|---|---|
| set | Y | M | C | BK | Y | M | C | BK |
| 101 | A | A | A | A | A | A | A | A |
| 102 | A | A | A | A | B | A | A | A |
| 103 | A | A | A | A | A | A | A | A |
| 104 | A | A | A | A | A | A | A | A |
| 105 | A | A | A | A | A | A | A | A |
| 106 | A | A | A | A | A | A | A | A |
| 107 | A | A | A | A | A | A | A | A |
| 108 | A | A | A | A | B | A | A | A |
| 109 | A | A | A | A | A | A | A | A |
| 110 | A | A | A | A | A | A | A | A |
| 111 | A | A | A | A | A | A | A | A |
| 112 | A | A | A | A | A | A | A | A |
| 113 | A | C | A | B | A | B | A | A |

The evaluation results revealed an excellent ability of the ink of the example that it is excellent in printing ability, has high water resistance, stiffness and over abrasion resistance, and has low paper dependency. Also, when narrow lines are output, the narrow lines cause no blotting and are excellent. Particularly when M-6 and C-1 are used as the oil-soluble dye, images having extremely excellent color reproducibility are obtained.

Further, the same evaluation results were obtained even when the recording paper was replaced by “PM PHOTO PAPER” manufactured by EPSON and “PR101” manufactured by CANON.

### EXAMPLE 2

The Ink sets 101 to 113 produced in Example 1 were filled into a cartridge of an ink-jet printer, BJ-F850 (manufactured by CANON), images were printed on ink-jet paper, photo gloss paper EX (recording paper in which an ink receiving layer contains a white pigment), manufactured by Fuji Photo Film Co., Ltd,. using the same machine, and the same evaluations as in Example 1 were conducted. As a result, the same evaluation results as in Example 1 were obtained. Further, the same evaluation results were obtained even when the recording paper was replaced by “PM PHOTO PAPER” manufactured by EPSON and “PR101” manufactured by CANON.

According to the present invention, a coloring composition can be provided which is excellent in handling properties, odor, safety and dispersion stability of a coloring particulate, has no paper dependency, is excellent in color developing property and hue when printed on any type of paper, shows excellent water resistance, light resistance and permeability into an image receiving material and manifests no staining directly after printing, and provides excellent stability of a dye with the passing of time, and is suitable for a water-based ink for writing, water-based printing ink, information recording ink and the like. Further, according to the present invention, an ink-jet ink and an ink-jet recording method can be provided which are suitable for a thermal, piezoelectric, electric field or acoustic ink-jet method, cause no clogging at the tip of nozzles when printing is conducted using the nozzles, have no paper dependency, manifest excellent permeability into any type of paper, particularly photo quality paper, and can form images having excellent color developing property and hue and also having excellent water resistance and light resistance.

What is claimed is:

1. An ink-jet ink comprising a coloring composition containing a coloring particulate containing an ionic-group-containing polymer, an oil-soluble dye, and a hydrophobic high-boiling-point organic solvent having a boiling point of at least 150° C., the coloring particulate being dispersed in a water-based medium, wherein content of the hydrophobic high-boiling-point organic solvent in the coloring composition is at least 25% by mass and not more than 95% by mass with respect to a total amount of the ionic-group-containing polymer, the oil-soluble dye, and the hydrophobic high-boiling-point organic solvent.

2. An ink-jet ink according to claim 1 wherein the oil-soluble dye is represented by following general formula I:
general formula I 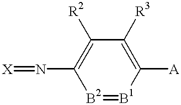
wherein X represents a residual group of a color coupler; A represents one of —NR⁴R⁵ and a hydroxy group; R⁴ and R⁵ each independently represents one of a hydrogen atom, aliphatic group, aromatic group and heterocyclic group; B¹ represents one group, aromatic group and heterocyclic group; B¹ represents one of ═C(R⁶)— and ═N—; B² represents one of —C(R⁷)═ and —N═; R², R³, R⁶ and R⁷ each independently represent one of a hydrogen atom, halogen atom, aliphatic group, aromatic group, heterocyclic group, cyano group, —OR⁵¹, —SR⁵², —CO₂R⁵³, —OCOR⁵⁴, —NR⁵⁵R⁵⁶, —CONR⁵⁷R⁵⁸, —SO₂R⁵⁹, —SO₂NR⁶⁰R⁶¹, —NR⁶²CONR⁶³R⁶⁴, —NR⁶⁵CO₂R⁶⁶, —COR⁶⁷, —NR⁶⁸COR⁶⁹, and —NR⁷⁰SO₂R⁷¹; R⁵¹, R⁵², R⁵³, R⁵⁴, R⁵⁵, R⁵⁶, R⁵⁷, R⁵⁸, R⁵⁹, R⁶⁰, R⁶¹, R⁶², R⁶³, R⁶⁴, R⁶⁵, R⁶⁶, R⁶⁷, R⁶⁸, R⁶⁹, R⁷⁰ and R⁷¹ each independently represents one of a hydrogen atom, aliphatic group and aromatic group; and any of pairs, R² and R³, R³ and R⁴, R⁴ and R⁵, R⁵ and R⁶, and R⁶ and R⁷ may bond together to form a ring structure.

3. An ink-jet ink according to claim 1, wherein the ionic-group-containing polymer is a vinyl polymer.

4. An ink-jet ink according to claim 1, wherein a relative dielectric constant at 25° C. of the hydrophobic high-boiling-point organic solvent is from 3 to 12.

5. An ink-jet ink according to claim 1, wherein the vinyl polymer has at least one of carboxyl groups and sulfonic acid groups as ionic groups.

6. An ink-jet ink according to claim 1, wherein the hydrophobic high-boiling-point organic solvent is at least one hydrophobic high-boiling-point organic solvent selected from hydrophobic high-boiling-point organic solvents represented by following formulae S-1 to S-9: 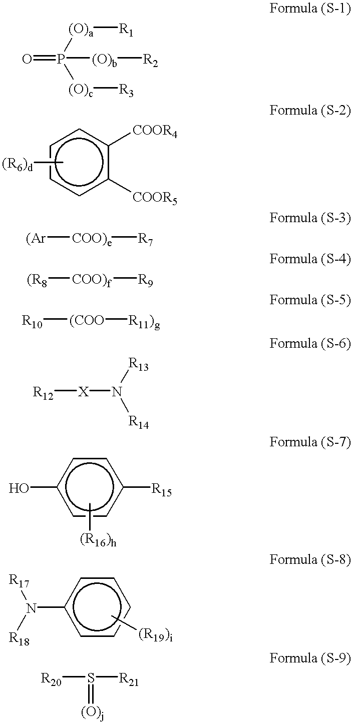
wherein: in the formula S-1, R₁, R₂ and R₃ each independently represents one of an aliphatic group and an aryl group, and a, b and c each independently represents 0 or 1;
in the formula S-2, R₄ and R₅ each independently represents one of an aliphatic group and an aryl group, R₆ represents one of a fluorine atom, chlorine atom, bromine atom, iodine atom, alkyl group, alkoxy group, aryloxy group, alkoxycarbonyl group and aryloxycarbonyl group, d represents an integer from 0 to 3, and, in a case where d is more than 1, one R₆ may be different from another R₆;
in the formula S-3, Ar represents an aryl group, e represents an integer from 1 to 6, and R₇ represents one of an e-valent hydrocarbon group and a hydrocarbon group that is mutually bonded by an ether bond;
in the formula S-4, R₈ represents an aliphatic group, f represents an integer from 1 to 6, and R₉ represents one of an f-valent hydrocarbon group and a hydrocarbon group that is mutually bonded by an ether bond;
in the formula S-5, g represents an integer from 2 to 6, R₁₀ represents a g-valent hydrocarbon group other than an aryl group, and R₁₁ represents one of an aliphatic group and an aryl group;
in the formula S-6, R₁₂, R₁₃ and R₁₄ each independently represents one of a hydrogen atom, aliphatic group and aryl group, X represents one of —CO— and —SO₂—, and one of a pair R₁₂ and R₁₃ and a pair R₁₃ and R₁₄ may bond together mutually to form a ring;
in the formula S-7, R₁₅ represents one of an aliphatic group, alkoxycarbonyl group, aryloxycarbonyl group, alkylsulfonyl group, arylsulfonyl group, aryl group and cyano group, R₁₆ represents one of a fluorine atom, chlorine atom, bromine atom, iodine atom, aliphatic group, aryl group, alkoxy group and aryloxy group, h represents an integer from 0 to 3, and in a case where h is more than 1, one R₁₆ may be different form another R₁₆;
in the formula S-8, R₁₇ and R₁₈ each independently represents one of an aliphatic group and an aryl group, R₁₉ represents one of a fluorine atom, chlorine atom, brorine atom, iodine atom, aliphatic group, aryl group, alkoxy group and aryloxy group, i represents an integer from 0 to 4, and, in a case where i is more than 1, one R₁₉ may be different from another R₁₉;
in the formula S-9, R₂₀ and R₂₁ each independently represents an aliphatic group or aryl group, and j represents 1 or 2.

7. An ink-jet ink according to claim 1, wherein the content of the ionic-group-containing polymer is 1 to 70% by mass with respect to the total amount of the ionic-group-containing polymer, the oil-soluble dye, and the hydrophobic high-boiling-point organic solvent.

8. An ink-jet ink according to claim 1, wherein the content of the oil-soluble dye is 3 to 70% by mass with respect to the total amount of the ionic-group-containing polymer, the oil-soluble dye, and the hydrophobic high-boiling-point organic solvent.

9. An ink-jet ink according to claim 1, wherein average particle size of the coloring particulate is at most 100 nm.

10. An ink-jet ink according to claim 2, wherein the oil-soluble dye which is represented in said general formula I is a compound which is represented in the following general formula II:
General Formula II [chemical structure]
wherein, R², R³, A, B¹, and B² are synonymous with R², R³, A, B¹, and B² in said general formula I;
R¹ represents one of a hydrogen atom, an aliphatic group, an aromatic group, a heterocyclic group, a cyano group, —OR¹¹, —SR¹², —CO₂R¹³, —OCOR¹⁴, —NR¹⁵R¹⁶, —CONR¹⁷R¹⁸, —SO₂R¹⁹, —SO₂NR²⁰R²¹, —NR²²CONR²³R²⁴, —NR²⁵CO₂R²⁶, —COR²⁷, —NR²⁸COR²⁹, and —NR³⁰SO₂R³¹;
R¹¹, R¹², R¹³, R¹⁴, R¹⁵, R¹⁶, R¹⁷, R¹⁸, R¹⁹, R²⁰, R²¹, R²², R²³, R²⁴, R²⁵, R²⁶, R²⁷, R²⁸, R²⁹, R³⁰, and R³¹ represent respectively independently one of a hydrogen atom, an aliphatic group, and an aromatic group;
D represents an atom group which forms one of a five-membered nitrogen-containing heterocyclic ring and a six-membered nitrogen-containing heterocyclic ring which may be substituted for at least one of an aliphatic group, an aromatic group, a heterocyclic group, a cyano group, —OR⁸¹, —SR⁸², —CO₂R⁸³, —OCOR⁸⁴, —NR⁸⁵R⁸⁶, —CONR⁸⁷R⁸⁸, —SO₂R⁸⁹, —SO₂NR⁹⁰R⁹¹, —NR⁹²CONR⁹³R⁹⁴, —NR⁹⁵CO₂R⁹⁶, —COR⁹⁷, —NR⁹⁸COR⁹⁹, and —NR¹⁰⁰SO₂R¹⁰¹;
the heterocyclic ring may further form a condensed ring with another ring; and
R⁸¹, R⁸², R⁸³, R⁸⁴, R⁸⁵, R⁸⁶, R⁸⁷, R⁸⁸, R⁸⁹, R⁹⁰, R⁹¹, R⁹², R⁹³, R⁹⁴, R⁹⁵, R⁹⁶, R⁹⁷, R⁹⁸, R⁹⁹, R¹⁰⁰, and R¹⁰¹ represent respectively independently one of a hydrogen atom, an aliphatic group, and an aromatic group.

11. An ink-jet ink according to claim 10, wherein the compound which is represented in said general formula II is a compound which is represented in the following general formula III:
General formula III 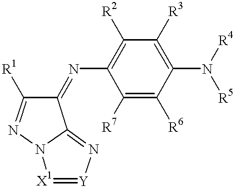
wherein, R¹, R², R³, R⁴, R⁵, R⁶, and R⁷ are synonymous with R¹, R², R³, R⁴, R⁵, R⁶, and R⁷ in said general formula II;
X¹ and Y represent respectively independently one of —C (R⁸)═ and —N═;
R⁸ represents one of a hydrogen atom, an aliphatic group, and an aromatic group; and
one of X¹ and Y is always —N═, and X¹ and Y are —N═ at different times.

12. An ink-jet ink according to claim 2, wherein the oil-soluble dye which is represented in said general formula I is at least one of compounds which are represented in the following formulas IV-1 to IV-4: 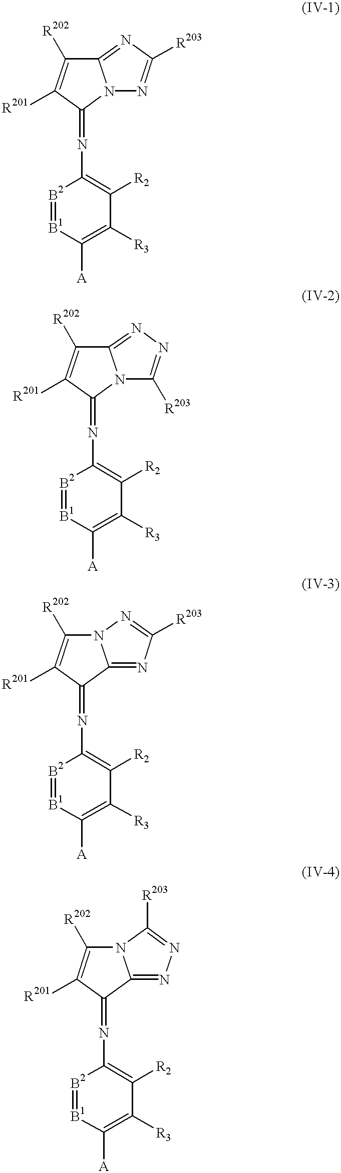
wherein, A, R², R³, B¹, and B² are synonymous with A, R², R³, B¹, and B² in said general formula I;
R²⁰¹, R²⁰², and R²⁰³ represent respectively independently one of a hydrogen atom, an aliphatic group, an aromatic group, a heterocyclic group, a cyano group, —OR¹¹, —SR¹², —CO₂R¹³, —OCOR¹⁴, —NR¹⁵R¹⁶, —CONR¹⁷R¹⁸, —SO₂R¹⁹, —SO₂NR²⁰R²¹, —NR²²CONR²³R²⁴, —NR²⁵CO₂R²⁶, —COR²⁷, —NR²⁸COR²⁹, and —NR³⁰SO₂R³¹;
R¹¹, R¹², R¹³, R¹⁴, R¹⁵, R¹⁶, R¹⁷, R¹⁸, R¹⁹, R²⁰, R²¹, R²², R²³, R²⁴, R²⁵, R²⁶, R²⁷, R²⁸, R²⁹, R³⁰, and R³¹ represent respectively independently one of a hydrogen atom, an aliphatic group, and an aromatic group; and
R²⁰¹ and R²⁰² may be combined with each other and form a ring structure.

13. A coloring composition comprising a coloring particulate containing an ionic-group-containing polymer, an oil-soluble dye, and a hydrophobic high-boiling-point organic solvent having a boiling point of at least 150° C., the coloring particulate being dispersed in a water-based medium, wherein content of the hydrophobic high-boiling-point organic solvent in the coloring composition is at least 25% by mass and not more than 95% by mass with respect to a total amount of the ionic-group-containing polymer, the oil-soluble dye, and the hydrophobic high-boiling-point organic solvent.

14. An ink-jet recording method in which recording is conducted using an ink-jet ink on a recording material, the ink comprising a coloring composition containing a coloring particulate containing an ionic-group-containing polymer, an oil-soluble dye, and a hydrophobic high-boiling-point organic solvent having a boiling point of at least 150° C., the coloring particulate being dispersed in a water-based medium, wherein content of the hydrophobic high-boiling-point organic solvent in the coloring composition is at least 25% by mass and not more than 95% by mass with respect to a total amount of the ionic-group-containing polymer, the oil-soluble dye, and the hydrophobic high-boiling-point organic solvent.

15. An ink-jet recording method according to claim 14 wherein the oil-soluble dye is represented by following general formula I:
general formula I 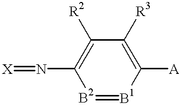
wherein X represents a residual group of a color coupler; A represents one of —NR⁴R⁵ and a hydroxy group; R⁴and R⁵ each independently represents one of a hydrogen atom, aliphatic group, aromatic group and heterocyclic group; B¹ represents one of ═C(R⁶)— and ═N—; B² represents one of —C(R⁷)═ and —N═; R², R³, R⁶ and R⁷ each independently represent one of a hydrogen atom, halogen atom, aliphatic group, aromatic group, heterocyclic group, cyano group, —OR⁵¹, —SR⁵², —CO₂R⁵³, —OCOR⁵⁴, —NR⁵⁵R⁵⁶, —CONR⁵⁷R⁵⁸, —SO₂R⁵⁹, —SO₂NR⁶⁰R⁶¹, —NR⁶²CONR⁶³R⁶⁴, —NR⁶⁵CO₂R⁶⁶, —COR⁶⁷, —NR⁶⁸COR⁶⁹, and —NR⁷⁰SO₂R⁷¹; R⁵¹, R⁵², R⁵³, R⁵⁴, R⁵⁵, R⁵⁶, R⁵⁷, R⁵⁸, R⁵⁹, R⁶⁰, R⁶¹, R⁶², R⁶³, R⁶⁴, R⁶⁵, R⁶⁶, R⁶⁷, R⁶⁸, R⁶⁹, R⁷⁰ and R⁷¹ each independently represents one of a hydrogen atom, aliphatic group and aromatic group; and any of pairs, R² and R³, R³ and R⁴, R⁴ and R⁵, R⁵ and R⁶, and R⁶ and R⁷ may bond together to form a ring structure.

16. An ink-jet recording method according to claim 14 wherein the recording material includes a substrate on which is provided an ink receiving layer containing a porous inorganic pigment.

17. An ink-jet recording method comprising the step of:
(a) preparing an ink-jet ink, containing coloring composition in which coloring particulate containing an ionic-group-containing polymer, an oil-soluble dye, and a hydrophobic high-boiling-point organic solvent having a boiling point of at least 150° C. are dispersed in an aqueous medium, with the content of the hydrophobic high-boiling-point organic solvent in the coloring composition being at least 25% by mass and not more than 95% by mass with respect to total amount of the ionic-group-containing polymer, the oil-soluble dye, and the hydrophobic high-boiling-point organic solvent,
(b) disposing the ink-jet ink in a cartridge adapted for use in an ink-jet printer, and
(c) using the cartridge in an ink jet printer for recording images.

18. An ink-jet recording method according to claim 17, wherein the step of preparing an ink-jet ink includes the sub-step of dispersing the ionic-group-containing polymer, the oil-soluble dye, and the hydrophobic high-boiling-point organic solvent by a co-emulsifying dispersion technique.
